(19) United States
(12) Patent Application Publication
(10) Pub. No.: US 2025/0136871 A1
(43) Pub. Date: May 1, 2025

(54) Process To Conduct the Pyrolysis of Biomass And/Or Waste Plastic in An Electrified Fluidized And/Or Spouted Bed Reactor

(71) Applicant: TOTALENERGIES ONETECH, Courbevoie (FR)

(72) Inventor: Walter VERMEIREN, Seneffe (BE)

(21) Appl. No.: 18/832,822

(22) PCT Filed: Jan. 18, 2023
(86) PCT No.: PCT/EP2023/051081

§ 371 Date: Jul. 24, 2024

(30) Foreign Application Priority Data
Feb. 1, 2022 (EP) 22315027.7

(51) Int. Cl. C10B 49/22; C10B 53/02; C10B 53/07; C10B 57/06; C10G 1/02

(52) U.S. Cl. CPC C10B 49/22; C10B 53/02; C10B 53/07; C10B 57/06; C10G 1/02; C10G 2300/1003; C10G 2300/1011

(57) ABSTRACT

The disclosure relates to a process to perform a pyrolysis reaction of biomass and/or waste plastic by employing a bed selected from a fluidized bed and/or a spouted bed, said bed having conductive particles and that is being heated by means of at least two electrodes applying an electric current through the bed of particles.

### FIELD OF THE DISCLOSURE

The present disclosure relates to a process for performing a pyrolysis reaction of biomass and/or waste plastic by employing a bed selected from a fluidized bed and/or a spouted bed, said bed having conductive particles and that is being heated by means of at least two electrodes applying an electric current through the bed of particles, wherein the reaction is performed without the need of an external heating device in respectively the said fluidized bed reactor and/or the said spouted bed reactor. The present disclosure aims to contribute to the replacement of the use of fossil carbon-based fuels heating devices. The present disclosure relates to the electrification of the chemical industry.

### TECHNICAL BACKGROUND

Climate change and ongoing energy transition make it mandatory to replace fossil carbon-based fuels in chemical production and recycled processes with a more environmentally friendly decarbonized source of energy.

On one hand, biomass is an abundant source of renewable energy, however its composition is far different from the well-known transportation fuels or main commodities like polyethylene, polypropylene, polystyrene and polyethylene-terephthalate. One way to use biomass is to decompose it into its constituting components (carbohydrates and lignin) that are further converted into for instance ethanol while the lignin part can be used as combustible for the process. Another way is to pyrolyze it at high temperature and process it further to obtain hydrocarbon-like molecules that can be blended with fossil fuels.

On the other hand, plastic are essential parts of society and are essentially all based on carbon. At the end of its use (life) waste plastics have to be recycled and reused again either by mechanical recycling or chemical recycling. The chemical recycling consists also in a pyrolysis step that makes an oil that can be used as a feedstock for steam crackers or blended with fossil fuels after appropriate post-treatment and hence closing the carbon loop.

The present disclosure aims to provide a large-scale solution to one or more of the problems encountered in the prior art that is suitable for application in the industry, such as the chemical industry. The present disclosure aims to contribute to the replacement of the use of fossil carbon-based fuels heating devices in fluidized bed reactors. The present disclosure provides a solution to conduct the pyrolysis of biomass and/or waste plastics.

Pyrolysis is the heating of the feedstock in the absence of oxygen at a specified heating rate to a definite temperature and holding it there for a certain time. During pyrolysis of biomass, large functional molecules are broken into relatively smaller ones via reactions such as depolymerization, dehydration, decarbonylation, decarboxylation, deoxygenation and recombined by oligomerization, condensation and aromatization, resulting in gas and liquid fractions that contain still a lot of bonded oxygen atoms beside significant amounts of biochar. During pyrolysis of waste plastics, the thermochemical process breaks down the long chain polymer molecules into smaller and less complex molecules through heat and chemical reactions, resulting in gas and liquid fractions that are rich in hydrocarbons (H/C ratio ˜1-2) beside some char (hydrogen poor solid fraction). The extent of these reactions and the relative contribution to final product composition is influenced by many factors such as heating rate, pyrolysis temperature, composition, and catalyst effect.

The term biomass refers to all biological matter, i.e., plants, animals, microorganisms, wood wastes, energy crops, aquatic plants, agricultural crops and forestry residue/waste, marine waste, manure, and animal, municipal and industrial organic waste that is directly or indirectly derived from the process of photosynthesis.

Energy crops, wood, agricultural and forest residue are the main sources of lignocellulosic biomass. Lignocellulosic biomass, generally considered as dry biomass, is composed of lignin, cellulose, and hemicellulose. The elemental composition mainly consists of carbon, hydrogen, and oxygen with traces of nitrogen, sulphur, and mineral impurity.

Algae contain organic and aqueous phase with the primary chemical composition of proteins, carbohydrates, lipids and nucleic acids, but contains very low lignin and crystalline cellulose contents and these compositions vary with strains. Algae are rich in nitrogen (5-10 wt. %) and ash (>5 wt. %).

Municipal solid waste collected mainly from households consists of plastics, paper, metals, textiles, organic waste, leather, rubber, metals, glass, ceramics, soil materials and miscellaneous other materials. Organic fraction of municipal solid waste is understood to be the part of solid waste constituted by those of organic origin, such as food remains, manure, tree pruning, street sweeping, branches, straw, and plants. The organic fraction of organic solid waste represents about 50% of this waste and contains mainly carbohydrates (30-40 wt. %), lipids (10-15 wt. %), and proteins (5-15 wt. %) and hence can contain still significant amounts of nitrogen (1-4 wt. %).

Sewage sludge is a waste material from wastewater treatment plants and is an ash-rich solid waste material. Sewage sludge contain mainly protein and carbohydrate with low lipid content.

Anaerobic digestion is a biological conversion process of biomass conversion (mainly animal manure). The process produces biogas, which is a blend of CO₂ (30-60 vol. %) and CH₄ (40-70 vol. %). Anaerobic sludge is a solid residue obtained from anaerobic digestion, which is 40-50 wt. % of the original organic material. The digestate has physical and chemical properties similar to municipal solid waste and sewage sludge. The term biomass refers to the anaerobic sludge, not to the biogas.

WO2022/023368 relates to a process to perform an endothermic pyrolysis reaction in which a methane feedstock which is gaseous is pyrolyzed.

FR 1 227 540 relates to the use of a fluidized bed to produce carbon disulphide or boron trichloride. CH 417 527 relates to the calcination and desulfuration of carbonaceous solids. US 2009/0078913 relates to a process for producing a carbonaceous material from starch. The study of Czajczyńska D. et al., entitled “Potential of pyrolysis processes in the waste management sector” (Thermal Science and Engineering Progress, 2017, 3, 171-197) investigates the link between the pyrolysis conditions, the chemical and mineralogical composition of their products and the benefits of pyrolysis in the waste management sector.

Plastic wastes are generally used for energy recovery, recycled, or sent to landfill. In municipal waste the largest fractions are PE, PP, PS, PET and PVC.

Pyrolysis is a thermochemical process for converting biomass or plastic materials into pyrolysis oil, gaseous products, and char. The process can be categorized into slow, fast, and flash pyrolysis. Each pyrolysis type has different products and their corresponding compositions. The composition and amount of pyrolysis products vary depending on the content of biomass or waste plastic constituents as well as the distribution and percentages of these constituents, which vary with biomass species or origin of the waste plastic. Pyrolysis occurs in a gas atmosphere by applying thermal heat to convert the biomass or plastic into numerous compounds, such as pyrolysis oil, gaseous products, and char. In case of biomass as feedstock, the liquid oil is a combination of many oxygenated organic compounds and water. In case of waste plastic, the liquid oil is a combination of mainly hydrocarbon compounds and some oxygenated organic compounds. Such products are formed depending on the various operation conditions, such as the rate of heating, operating temperature, residence time, and feedstock particle size.

Depending on the reaction conditions (see Pyrolysis of Biomass for Aviation Fuel, in Biofuels for Aviation. DOI: http://dx.doi.org/10.1016/B978-0-12-804568-8.00008-1, Elsevier), the ratio of the different fractions alters drastically for biomass pyrolysis:
Slower, low-temperature pyrolysis (400° C. (range 300° C.-700° C.), >10 minutes (range 10 min-100 min) vapor residence time, Feedstock size: 5-50 mm and Heating rate: 0.1-1° C./s) promotes a larger solid fraction ‘char’ (˜35 wt. %) and less oil (˜30 wt. %). Slow pyrolysis is also called carbonisation, and emphasises the solid char as main product
Fast, intermediate temperature pyrolysis (500° C. (range 400° C.-800° C.), 1 second vapor residence time (range 0.5 s-5 s), Heating rate: 50° C./s (range 10° C./s −200° C./s) and Feedstock size: <3 mm) results in more liquid oil (>50 wt. %) and less char (<30 wt. %).
Flash, high-temperature pyrolysis (800° C. (range 800° C.-1000° C.), <0.5 s vapor residence time, Heating rate: >1000° C./s and Feedstock size: <0.2 mm) gives liquid fractions of up to 75 wt. % and minimum amounts of char (˜12 wt. %).

Equally, depending on the reaction conditions (see Pyrolytic Conversion of Plastic Waste to Value-Added Products and Fuels: A Review. Materials 2021, 14, 2586. https://doi.org/10.3390/ma14102586; Plastics waste management: A review of pyrolysis technology, Clean Technologies and Recycling, 1 (1): 50-69. DOI: 10.3934/ctr.2021003, 2021; Thermochemical routes for the valorization of waste polyolefinic plastics to produce fuels and chemicals. A review, Renewable and Sustainable Energy Reviews, Volume 73, June 2017, Pages 346-368), the ratio of the different fractions alters drastically for plastic pyrolysis:
Slower, low-temperature pyrolysis (400° C. (range 350° C.-550° C.) and Heating rate: 0.01-0.2° C./s) promotes a larger solid fraction ‘char’ (1-50 wt. %), oil (10-90 wt. %) and the balance being gases. Slow pyrolysis is also called carbonisation and emphasises the solid char as main product.
Fast, intermediate temperature pyrolysis (600° C. (range 500° C.-750° C.), a few seconds vapor residence time (range 0.5 s-25 s) and heating rate: >15° C./s) results in more liquid oil (30-95 wt. %), less char (<10 wt. %) and the balance being gases (rich in monomers). The ratio liquid to gas depends on the operating conditions.
Flash, high-temperature pyrolysis (800° C. (range 700° C.-1000° C.), <1.0 s vapor residence time, Heating rate: >100° C./s) gives mainly gaseous fractions (60 wt. %-99 wt. %) and minimum amounts of char (<3 wt. %) and the balance being liquid oil.

Both pyrolysis of biomass and of plastic are endothermic reaction requiring supply of heat during the process. In case of biomass, the heat for pyrolysis (including sensible heat to bring feedstock to pyrolysis temperature) is about 500-4000 KJ/kg whereas the heat of pyrolysis (enthalpy of pyrolysis) is about 150-2000 KJ/kg (Biomass Fast Pyrolysis Energy Balance of a 1 kg/h Test Rig, International Journal of Thermodynamics, Vol. 18 (No. 4), pp. 267-275, 2015; Heat requirement for fixed bed pyrolysis of beechwood chips, Energy, Volume 178, 1 Jul. 2019, Pages 145-157. In case of plastic, the heat of pyrolysis is about 1200-7600 KJ/kg, depending on pyrolysis severity and feedstock composition (Energy- and economic-balance estimation of pyrolysis plant for fuel-gas production from plastic waste based on bench-scale plant operations, Fuel Communications, Volume 7, June 2021, 100016). The most common fast pyrolysis reactors (rotating cone, ablative, conical spouted bed, bubbling fluidized bed and circulating bed) that have been developed intending to optimize the yields of bio-oil. The present disclosure is related to the use of fluidized bed reactors, and/or spouted bed reactors.

### SUMMARY OF THE DISCLOSURE

According to a first aspect, the disclosure provides for a process to perform an endothermic pyrolysis reaction of biomass and/or waste plastic, said process comprising the steps of:
a) providing at least one bed reactor selected from a fluidized bed reactor and/or a spouted bed reactor, said bed reactor comprising at least two electrodes and a bed comprising particles;
b) putting the particles of the bed in a fluidized state by passing upwardly through the said bed a fluid stream, to obtain respectively a fluidized bed and/or a spouted bed; and
c) heating respectively the fluidized and/or the spouted bed to a temperature ranging from 400° C. to 900° C. to conduct the endothermic pyrolysis reaction of a biomass and/or waste plastic feedstock;
   the process is remarkable in that the particles of the bed comprise at least electrically conductive particles and in that at least 10 wt. % of the particles based on the total weight of the particles of the bed are electrically conductive particles and have a resistivity ranging from 0.001 Ohm·cm to 500 Ohm·cm at 600° C.; in that the step c) of heating respectively the fluidized bed and/or the spouted bed is performed by passing an electric current through respectively the fluidized bed and/or the spouted bed.

Surprisingly, it has been found that the use of electrically conductive particles, such as silicon carbide, mixed oxides and/or mixed sulphides, said mixed oxides and/or said mixed sulphides being an ionic or mixed conductor, namely being doped with one or more lower-valent cations, in one or more fluidized bed reactors, or in one or more spouted bed reactors, or in an arrangement of one or more fluidized bed reactors and one or more spouted bed reactors which are electrified, allows maintaining a temperature sufficient to carry out an endothermic pyrolysis reaction of biomass and/or waste plastic requesting high-temperature conditions such as temperature reaction ranging from 400° C. to 900° C. without the need of any external heating device. The use of at least 10 wt. % of electrically conductive particles within the particles of the bed allows minimizing the loss of heat when a voltage is applied. Thanks to the Joule effect, most, if not all, the electrical energy is transformed into heat that is used for the heating of the reactor medium.

For example, the electrically conductive particles are or comprise one or more selected from one or more metallic alloys, one or more non-metallic resistors, one or more metallic carbides, one or more metallic nitrides, one or more metallic phosphides, one or more carbon-containing particles, one or more superionic conductors, one or more phosphate electrolytes, one or more mixed oxides being doped with one or more lower-valent cations, one or more mixed sulphides being doped with one or more lower-valent cations, and any mixture thereof.

In preferred embodiment, the electrically conductive particles are or comprise one or more selected from one or more metallic alloys, one or more non-metallic resistors, one or more metallic carbides, one or more metallic nitrides, one or more metallic phosphides, graphite, carbon black, char, charcoal, coke, petroleum coke, one or more superionic conductors, one or more phosphate electrolytes, one or more mixed oxides being doped with one or more lower-valent cations, one or more mixed sulphides being doped with one or more lower-valent cations, and any mixture thereof.

Advantageously, said process further comprises a step d) of recovering one or more pyrolysis products of the reaction. Step d) is performed after step c).

In a preferred embodiment, the volumetric heat generation rate is greater than 0.1 MW/m³ of fluidized bed, more preferably greater than 1 MW/m³, in particular, greater than 3 MW/m³.

In a preferred embodiment, the at least one fluidized bed reactor and/or the at least one spouted bed reactor are devoid of heating means. For example, the at least one fluidized bed reactor and/or the at least one spouted bed reactor comprise a vessel and are devoid of heating means located around or inside the vessel. For example, at least one fluidized bed reactor and/or at least one spouted bed reactor are devoid of heating means selected from ovens, gas burners, hot plates, or any combination thereof. For example, all the fluidized bed reactors and/or all the spouted bed reactors are devoid of heating means selected from ovens, gas burners, hot plates, or any combination thereof.

For example, the content of electrically conductive particles is ranging from 10 wt. % to 100 wt. % based on the total weight of the particles of the bed; preferably, from 15 wt. % to 95 wt. %, more preferably from 20 wt. % to 90 wt. %, even more preferably from 25 wt. % to 80 wt. % and most preferably from 30 wt. % to 75 wt. %.

For example, the content of electrically conductive particles based on the total weight of the bed is at least 12 wt. % based on the total weight of the particles of the bed; preferably, at least 15 wt. %, more preferably, at least 20 wt. %; even more preferably at least 25 wt. %, and most preferably at least 30 wt. % or at least 40 wt. % or at least 50 wt. % or at least 60 wt. %.

For example, the electrically conductive particles have a resistivity ranging from 0.005 to 400 Ohm·cm at 600° C., preferably ranging from 0.01 to 300 Ohm·cm at 600° C.; more preferably ranging from 0.05 to 150 Ohm·cm at 600° C. and most preferably ranging from 0.1 to 100 Ohm·cm at 600° C.

For example, the electrically conductive particles have a resistivity of at least 0.005 Ohm·cm at 600° C.; preferably of at least 0.01 Ohm·cm at 600° C., more preferably of at least 0.05 Ohm·cm at 600° C.; even more preferably of at least 0.1 Ohm·cm at 600° C., and most preferably of at least 0.5 Ohm·cm at 600° C.

For example, the electrically conductive particles have a resistivity of at most 400 Ohm·cm at 600° C.; preferably of at most 300 Ohm·cm at 600° C., more preferably of at most 200 Ohm·cm at 600° C.; even more preferably of at most 150 Ohm·cm at 600° C., and most preferably of at most 100 Ohm·cm at 600° C. The selection of the content of electrically conductive particles based on the total weight of the particles of the bed and of the electrically conductive particles of a given resistivity influence the temperature reached by the fluidized bed or the spouted bed. Thus, in case the targeted temperature is not attained, the person skilled in the art may increase the density of the bed of particles, the content of electrically conductive particles based on the total weight of the particles of the bed and/or select electrically conductive particles with a lower resistivity to increase the temperature reach by the fluidized bed or the spouted bed.

For example, the density of the bed of particles is expressed as the void fraction. Void fraction or bed porosity is the volume of voids between the particles divided by the total volume of the bed. At the incipient fluidisation velocity, the void fraction is typically between 0.4 and 0.5. The void fraction can increase up to 0.98 in fast fluidised beds with lower values at the bottom of about 0.5 and higher than 0.9 at the top of the bed. The void fraction can be controlled by the linear velocity of the fluidising gas and can be decreased by recycling solid particles that are recovered at the top and send back to the bottom of the fluidized bed or the spouted bed, which compensates for the entrainment of solid particles out of the bed.

The void fraction VF is defined as the volume fraction of voids in a bed of particles and is determined according to the following equation:

$$V F = \frac{V t - V p}{V t} \qquad ( 1 )$$

wherein Vt is the total volume of the bed and is determined by

$$Vt = AH \qquad ( 2 )$$

wherein A is the integrated (over the height) cross-sectional area of the fluidized bed and/or the spouted bed and H is the height of the fluidized bed or the spouted bed; and
wherein Vp is the total volume of particles within the fluidized bed or the spouted bed.

For example, the average void fraction of the bed is ranging from 0.5 to 0.8; preferably ranging from 0.5 to 0.7, more preferably from 0.5 to 0.6. To increase the density of the bed of particles, the void fraction is to be reduced.

For example, the particles of the bed have an average particle size ranging from 5 to 300 μm as determined by sieving according to ASTM D4513-11, preferably ranging from 10 to 200 μm and more preferably ranging from 20 to 200 μm or from 30 to 150 μm.

Determination by sieving according to ASTM D4513-11 is preferred. In case the particles have an average size of below 20 μm the determination of the average size can also be done by Laser Light Scattering according to ASTM D4464-15.

For example, the electrically conductive particles of the bed have an average particle size ranging from 5 to 300 μm as determined by sieving according to ASTM D4513-11, preferably ranging from 10 to 200 μm and more preferably ranging from 30 to 150 μm.

In an embodiment, from 50 wt. % to 100 wt. % of the electrically conductive particles of the bed based on the total weight of the electrically conductive particles of the bed are one or more selected from graphite, carbon black, char, charcoal, coke, petroleum coke, one or more metallic alloys, one or more non-metallic resistors, one or more metallic carbides, one or more metallic nitrides, one or more metallic phosphides, one or more superionic conductors, one or more phosphate electrolytes, one or more mixed oxides being doped with one or more lower-valent cations, one or more mixed sulphides being doped with one or more lower-valent cations, and any mixture thereof; preferably, from 60 wt. % to 100 wt. %; more preferably from 70 wt. % to 100 wt. %; even more preferably from 80 wt. % to 100 wt. % and most preferably from 90 wt. % to 100 wt. %.

In an embodiment, from 50 wt. % to 100 wt. % of the electrically conductive particles of the bed based on the total weight of the electrically conductive particles of the bed are one or more selected from graphite, carbon black, char, charcoal, coke, petroleum coke, one or more non-metallic resistors, one or more metallic carbides, one or more metallic nitrides, one or more metallic phosphides, one or more superionic conductors, one or more phosphate electrolytes, one or more mixed oxides being doped with one or more lower-valent cations, one or more mixed sulphides being doped with one or more lower-valent cations, and any mixture thereof; preferably, from 60 wt. % to 100 wt. %; more preferably from 70 wt. % to 100 wt. %; even more preferably from 80 wt. % to 100 wt. % and most preferably from 90 wt. % to 100 wt. %.

In an embodiment, from 50 wt. % to 100 wt. % of the electrically conductive particles of the bed based on the total weight of the electrically conductive particles of the bed are one or more selected from graphite, one or more metallic alloys, one or more non-metallic resistors, one or more metallic carbides, one or more metallic nitrides, one or more metallic phosphides, one or more superionic conductors, one or more phosphate electrolytes, one or more mixed oxides being doped with one or more lower-valent cations, one or more mixed sulphides being doped with one or more lower-valent cations, and any mixture thereof; preferably, from 60 wt. % to 100 wt. %; more preferably from 70 wt. % to 100 wt. %; even more preferably from 80 wt. % to 100 wt. % and most preferably from 90 wt. % to 100 wt. %.

In an embodiment, from 50 wt. % to 100 wt. % of the electrically conductive particles of the bed based on the total weight of the electrically conductive particles of the bed are one or more selected from carbon black, one or more metallic alloys, one or more non-metallic resistors, one or more metallic carbides, one or more metallic nitrides, one or more metallic phosphides, one or more superionic conductors, one or more phosphate electrolytes, one or more mixed oxides being doped with one or more lower-valent cations, one or more mixed sulphides being doped with one or more lower-valent cations, and any mixture thereof; preferably, from 60 wt. % to 100 wt. %; more preferably from 70 wt. % to 100 wt. %; even more preferably from 80 wt. % to 100 wt. % and most preferably from 90 wt. % to 100 wt. %.

In an embodiment, from 50 wt. % to 100 wt. % of the electrically conductive particles of the bed based on the total weight of the electrically conductive particles of the bed are one or more selected from char, one or more metallic alloys, one or more non-metallic resistors, one or more metallic carbides, one or more metallic nitrides, one or more metallic phosphides, one or more superionic conductors, one or more phosphate electrolytes, one or more mixed oxides being doped with one or more lower-valent cations, one or more mixed sulphides being doped with one or more lower-valent cations, and any mixture thereof; preferably, from 60 wt. % to 100 wt. %; more preferably from 70 wt. % to 100 wt. %; even more preferably from 80 wt. % to 100 wt. % and most preferably from 90 wt. % to 100 wt. %.

In an embodiment, from 50 wt. % to 100 wt. % of the electrically conductive particles of the bed based on the total weight of the electrically conductive particles of the bed are one or more selected from charcoal, one or more metallic alloys, one or more non-metallic resistors, one or more metallic carbides, one or more metallic nitrides, one or more metallic phosphides, one or more superionic conductors, one or more phosphate electrolytes, one or more mixed oxides being doped with one or more lower-valent cations, one or more mixed sulphides being doped with one or more lower-valent cations, and any mixture thereof; preferably, from 60 wt. % to 100 wt. %; more preferably from 70 wt. % to 100 wt. %; even more preferably from 80 wt. % to 100 wt. % and most preferably from 90 wt. % to 100 wt. %.

In an embodiment, from 50 wt. % to 100 wt. % of the electrically conductive particles of the bed based on the total weight of the electrically conductive particles of the bed are one or more selected from coke, one or more metallic alloys, one or more non-metallic resistors, one or more metallic carbides, one or more metallic nitrides, one or more metallic phosphides, one or more superionic conductors, one or more phosphate electrolytes, one or more mixed oxides being doped with one or more lower-valent cations, one or more mixed sulphides being doped with one or more lower-valent cations, and any mixture thereof; preferably, from 60 wt. % to 100 wt. %; more preferably from 70 wt. % to 100 wt. %; even more preferably from 80 wt. % to 100 wt. % and most preferably from 90 wt. % to 100 wt. %.

In an embodiment, from 50 wt. % to 100 wt. % of the electrically conductive particles of the bed based on the total weight of the electrically conductive particles of the bed are one or more selected from petroleum coke, one or more metallic alloys, one or more non-metallic resistors, one or more metallic carbides, one or more metallic nitrides, one or more metallic phosphides, one or more superionic conductors, one or more phosphate electrolytes, one or more mixed oxides being doped with one or more lower-valent cations, one or more mixed sulphides being doped with one or more lower-valent cations, and any mixture thereof; preferably, from 60 wt. % to 100 wt. %; more preferably from 70 wt. % to 100 wt. %; even more preferably from 80 wt. % to 100 wt. % and most preferably from 90 wt. % to 100 wt. %.

For example, the electrically conductive particles of the bed are devoid of one or more carbon-containing particles selected from petroleum coke, carbon black, char, charcoal, coke or a mixture thereof.

In a preferred embodiment, the electrically conductive particles of the bed comprise the char product of the pyrolysis reaction that can remain in the fluidized bed reactor or in the spouted bed reactor or can be recycled from the separation of the pyrolysis products back into respectively the fluidized bed reactor or into the spouted bed reactor. Biochar and char from plastic pyrolysis have resistivities as reported in literature of about 0.4 to 400 Ohm·cm, measured at room temperature (Electrical conductivity of wood biochar monoliths and its dependence on pyrolysis temperature. Biochar 2, 369-378 (2020); Environ. Sci. Technol. Lett. 2014, 1 (8), 339-344; Biochar as a low-cost, eco-friendly, and electrically conductive material for terahertz applications. Sci Rep 11, 18498 (2021); Carbon, Volume 39, Issue 8, July 2001, Pages 1147-1158). It is generally known that resistivity lowers with increasing temperature for carbon-containing solids (Processes 2020, 8, 933; doi: 10.3390/pr8080933).

Alternatively, the electrically conductive particles of the bed are or comprise graphite and one or more selected from one or more metallic alloys, one or more non-metallic resistors, one or more metallic carbides, one or more metallic nitrides, one or more metallic phosphides, one or more carbon-containing particles, one or more superionic conductors, one or more phosphate electrolytes, one or more mixed oxides being doped with one or more lower-valent cations, one or more mixed sulphides being doped with one or more lower-valent cations, and any mixture thereof; with preference in a content of from 50 wt. % to 100 wt. % based on the total weight of the electrically conductive particles of the bed; preferably, from 60 wt. % to 100 wt. %; more preferably from 70 wt. % to 100 wt. %; even more preferably from 80 wt. % to 100 wt. % and most preferably from 90 wt. % to 100 wt. %.

As an alternative, the electrically conductive particles of the bed are one or more particles selected from one or more metallic alloys, one or more non-metallic resistors provided that the non-metallic resistor is not silicon carbide, one or more metallic carbides, one or more metallic nitrides, one or more metallic phosphides, graphite, carbon black, char, charcoal, coke, petroleum coke, one or more superionic conductors, one or more phosphate electrolytes, one or more mixed oxides being doped with one or more lower-valent cations and/or one or more and/or mixed sulphides being doped with one or more lower-valent cations and any mixture thereof; with preference in a content of from 50 wt. % to 100 wt. % based on the total weight of the electrically conductive particles of the bed; preferably, from 60 wt. % to 100 wt. %; more preferably from 70 wt. % to 100 wt. %; even more preferably from 80 wt. % to 100 wt. % and most preferably from 90 wt. % to 100 wt. %.

For example, the electrically conductive particles of the bed are or comprise one or more selected from one or more metallic alloys, one or more non-metallic resistors, graphite, carbon black, one or more mixed oxides being doped with one or more lower-valent cations, one or more mixed sulphides being doped with one or more lower-valent cations, and any mixture thereof; with preference, in a content of from 50 wt. % to 100 wt. % based on the total weight of the electrically conductive particles of the bed; preferably, from 60 wt. % to 100 wt. %; more preferably from 70 wt. % to 100 wt. %; even more preferably from 80 wt. % to 100 wt. % and most preferably from 90 wt. % to 100 wt. %.

For example, the electrically conductive particles of the bed are or comprise graphite and one or more selected from one or more metallic alloys, one or more non-metallic resistors, one or more mixed oxides being doped with one or more lower-valent cations, one or more mixed sulphides being doped with one or more lower-valent cations, and any mixture thereof; with preference in a content of from 50 wt. % to 100 wt. % based on the total weight of the electrically conductive particles of the bed; preferably, from 60 wt. % to 100 wt. %; more preferably from 70 wt. % to 100 wt. %; even more preferably from 80 wt. % to 100 wt. % and most preferably from 90 wt. % to 100 wt. %.

For example, the electrically conductive particles of the bed are or comprise one or more selected from one or more metallic alloys, one or more non-metallic resistors, one or more mixed oxides being doped with one or more lower-valent cations, one or more mixed sulphides being doped with one or more lower-valent cations, and any mixture thereof; with preference, in a content of from 50 wt. % to 100 wt. % based on the total weight of the electrically conductive particles of the bed; preferably, from 60 wt. % to 100 wt. %; more preferably from 70 wt. % to 100 wt. %; even more preferably from 80 wt. % to 100 wt. % and most preferably from 90 wt. % to 100 wt. %.

For example, the electrically conductive particles of the bed are or comprise one or more selected from one or more non-metallic resistors, one or more mixed oxides being doped with one or more lower-valent cations, one or more mixed sulphides being doped with one or more lower-valent cations, and any mixture thereof; with preference in a content of from 50 wt. % to 100 wt. % based on the total weight of the electrically conductive particles of the bed; preferably, from 60 wt. % to 100 wt. %; more preferably from 70 wt. % to 100 wt. %; even more preferably from 80 wt. % to 100 wt. % and most preferably from 90 wt. % to 100 wt. %. For example, said one or more metallic alloys are selected from Ni—Cr, Fe—Ni—Cr, Fe—Ni—Al or a mixture thereof. With preference, when said metallic alloy comprises at least chromium, the chromium content is at least 15 mol. % of the total molar content of said metallic alloy comprising at least chromium, more preferably at least 20 mol. %, even more preferably at least 25 mol. %, most preferably at least 30 mol. %. Advantageously yet, the iron content in the metallic alloys is at most 2.0% based on the total molar content of the said metallic alloy, preferably at most 1.5 mol. %, more preferably at most 1.0 mol. %, even more preferably at most 0.5 mol. %.

For example, a non-metallic resistor is silicon carbide (SiC), molybdenum disilicide (MoSi₂), nickel silicide (NiSi), sodium silicide (Na₂Si), magnesium silicide (Mg₂Si), platinum silicide (PtSi), titanium silicide (TiSi₂), tungsten silicide (WSi₂) or a mixture thereof, preferably silicon carbide.

For example, said one or more metallic carbides are selected from iron carbide (Fe₃C) and/or molybdenum carbide (such as a mixture of MoC and Mo₂C).

For example, said one or more metallic nitrides are selected from zirconium nitride (ZrN), tungsten nitride (such as a mixture of W₂N, WN, and WN₂), vanadium nitride (VN), tantalum nitride (TaN), and/or niobium nitride (NbN).

For example, said one or more metallic phosphides are selected from copper phosphide (Cu₃P), indium phosphide (InP), gallium phosphide (GaP), sodium phosphide Na₃P), aluminium phosphide (AlP), zinc phosphide (Zn₃P₂) and/or calcium phosphide (Ca₃P₂).

For example, said one or more carbon-containing particles are selected from graphite, carbon black, char, charcoal, petroleum coke, coke or any combination thereof.

For example, said one or more superionic conductors are selected from LiAlSiO₄, Li₁₀GeP₂S₁₂, Li_{3.6}Si_{0.6}P_{0.4}O₄, sodium c conductors (NaSICON), such as Na₃Zr₂PSi₂O₁₂, or sodium beta alumina, such as NaAl₁₁O₁₇, Na_{1.6}Al₁₁O_{17.3}, and/or Na_{1.76}Li_{0.38}Al_{10.62}O₁₇.

For example, said one or more phosphate electrolytes are selected from LiPO₄ or LaPO₄.

For example, said one or more mixed oxides are ionic or mixed conductors being doped with one or more lower-valent cations. Advantageously, said mixed oxides are doped with one or more lower-valent cations, and are selected from oxides having a cubic fluorite structure, perovskite, pyrochlore.

For example, said one or more mixed sulphides are ionic or mixed conductors being doped with one or more lower-valent cations.

For example, the electrically conductive particles of the bed are or comprise a non-metallic resistor being silicon carbide.

For example, the electrically conductive particles of the bed are or comprise a mixture of a non-metallic resistor being silicon carbide and electrically conductive particles different from silicon carbide. The presence of electrically conductive particles different from silicon carbide in the bed is optional. It can be present as a starting material for heating the bed since it was found that the resistivity of silicon carbide at room temperature is too high to start heating the bed. Alternatively, to the presence of electrically conductive particles different from silicon carbide, it is possible to provide heat to the reactor for a defined time to start the reaction.

For example, the silicon carbide is selected from sintered silicon carbide, nitride-bounded silicon carbide, recrystallised silicon carbide, reaction bonded silicon carbide and any mixture thereof. The type of silicon carbide material is selected according to the required heating power necessary for supplying the reaction heat of the endothermic pyrolysis reaction of biomass and/or waste plastic.

For example, the electrically conductive particles of the bed are or comprise a mixture of a non-metallic resistor being silicon carbide and electrically conductive particles different from silicon carbide and the electrically conductive particles of the bed comprises from 10 wt. % to 99 wt. % of silicon carbide based on the total weight of the electrically conductive of the bed; preferably, from 15 wt. % to 95 wt. %, more preferably from 20 wt. % to 90 wt. %, even more preferably from 25 wt. % to 80 wt. % and most preferably from 30 wt. % to 75 wt. %.

For example, the electrically conductive particles of the bed are or comprise a mixture of a non-metallic resistor being silicon carbide and electrically conductive particles different from silicon carbide and the said electrically conductive particles different from silicon carbide are graphite and/or one or more mixed oxides being doped with one or more lower-valent cations and/or one or more mixed sulphides being doped with one or more lower-valent cations.

For example, the electrically conductive particles of the bed are or comprise one or more mixed oxides being ionic conductor, namely being doped with one or more lower-valent cations; with preference, the mixed oxides are selected from:
one or more oxides having a cubic fluorite structure being at least partially substituted with one or more lower-valent cations, preferentially selected from Sm, Gd, Y, Sc, Yb, Mg, Ca, La, Dy, Er, Eu; and/or
one or more ABO₃-perovskites with A and B tri-valent cations, being at least partially substituted in A position with one or more lower-valent cations, preferentially selected from Ca, Sr, or Mg, and comprising at least one of Ni, Ga, Co, Cr, Mn, Sc, Fe and/or a mixture thereof in B position; and/or
one or more ABO₃-perovskites with A bivalent cation and B tetra-valent cation, being at least partially substituted with one or more lower-valent cations, preferentially selected from magnesium (Mg), scandium (Sc), yttrium (Y), neodymium (Nd) or ytterbium (Yb) in the B position or with a mixture of different B elements in the B position; and/or.
one or more A₂B₂O₇-pyrochlores with A trivalent cation and B tetra-valent cation being at least partially substituted in A position with one or more lower-valent cations, preferentially selected from Ca or Mg, and comprising at least one of Sn, Zr and Ti in B position.

For example, the electrically conductive particles of the bed are or comprise one or more mixed sulphides being ionic conductor, namely being doped with one or more lower-valent cations; with preference, the mixed sulphide are selected from
one or more sulphides having a cubic fluorite structure being at least partially substituted with one or more lower-valent cations, preferentially selected from Sm, Gd, Y, Sc, Yb, Mg, Ca, La, Dy, Er, Eu; and/or
one or more ABS₃ structures with A and B tri-valent cations being at least partially substituted in A position with one or more lower-valent cations, preferably selected from Ca, Sr, or Mg and comprising at least one of Ni, Ga, Co, Cr, Mn, Sc, Fe and/or a mixture thereof in B position; and/or
one or more ABS₃ structures with A bi-valent cation and B tetra-valent cation, being at least partially substituted with one or more lower-valent cations, preferably selected from Mg, Sc, Y, Nd or Yb in the B position or with a mixture of different B elements in the B position; and/or
one or more A₂B₂S₇ structures with A tri-valent cation and B tetra-valent cation, being at least partially substituted in A position with one or more lower-valent cations, preferably selected from Ca or Mg, and comprising at least one of Sn, Zr and Ti in B position.

With preference, the degree of substitution in the one or more mixed oxides doped with one or more lower-valent cations and having a cubic fluorite structure is between 1 and 15 atom % based on the total number of atoms present in the one or more oxides having a cubic fluorite structure, preferably between 3 and 12 atom %, more preferably between 5 and 10 atom %.

With preference, the degree of substitution in the one or more mixed oxides doped with one or more lower-valent cations is between 1 and 50 atom % based on the total number of atoms present in the one or more ABO₃-perovskites with A and B tri-valent cations, in the one or more ABO₃-perovskites with A bivalent cation and B tetra-valent cation or in the one or more A₂B₂O₇-pyrochlores with A trivalent cation and B tetra-valent cation respectively, preferably between 3 and 20 atom %, more preferably between 5 and 15 atom %.

With preference, the degree of substitution in the one or more mixed sulphides doped with one or more lower-valent cations and having a cubic fluorite structure is between 1 and 15 atom % based on the total number of atoms present in the one or more oxides having a cubic fluorite structure, preferably between 3 and 12 atom %, more preferably between 5 and 10 atom %.

With preference, the degree of substitution in the one or more mixed sulphides doped with one or more lower-valent cations is between 1 and 50 atom % based on the total number of atoms present in the one or more ABS₃ structures with A and B tri-valent cations, in the one or more ABS₃ structures with A bivalent cation and B tetra-valent cation or in the one or more A₂B₂S₇ structures with A trivalent cation and B tetra-valent cation respectively, preferably between 3 and 20 atom %, more preferably between 5 and 15 atom %.

For example, the electrically conductive particles of the bed are or comprise one or more metallic alloys; with preference, one or more metallic alloys are selected from Ni—Cr, Fe—Ni—Cr, Fe—Ni—Al or a mixture thereof.

With preference, when said metallic alloy comprises at least chromium, the chromium content is at least 15 mol. % of the total molar content of said metallic alloy comprising at least chromium, more preferably at least 20 mol. %, even more preferably at least 25 mol. %, most preferably at least 30 mol. %. Advantageously yet, the iron content in the metallic alloys is at most 2.0% based on the total molar content of said metallic alloy, preferably at most 1.5 mol. %, more preferably at most 1.0 mol. %, even more preferably at most 0.5 mol. %.

For example, the electrically conductive particles of the bed are or comprise a mixture of a non-metallic resistor being silicon carbide and particles different from silicon carbide wherein the particles different from silicon carbide are or comprise graphite; with preference, said graphite is graphite particles having an average particle size ranging from 5 to 300 μm as determined by sieving according to ASTM D4513-11, more preferably ranging from 10 to 200 μm and most preferably ranging from 30 to 150 μm.

For example, the pyrolysis reaction is conducted at a temperature ranging from 400° C. to 900° C., preferably from 425° C. to 800° C., more preferably from 450° C. to 700° C. and most preferably from 500° C. to 650° C.

For example, the pyrolysis reaction is performed at a pressure ranging between 0.1 MPa and 1.0 MPa, preferably between 0.12 MPa and 0.5 MPa.

In an embodiment, said process comprises a step of pre-heating with a gaseous stream said fluidized bed reactor and/or said spouted bed reactor before conducting the pyrolysis reaction respectively in the fluidized bed reactor or in the spouted bed reactor; with preference, said gaseous stream is a stream of inert gas and/or has a temperature comprised between 200° C. and 500° C. The said embodiment is of interest when the particles of the bed such as graphite and/or the electro-resistive material have too high resistivity at room temperature to start the electro-heating of the bed.

The pyrolysis of biomass and/or plastic can be carried out with the help of a catalyst. To perform the catalytic pyrolysis reaction, the bed particles further comprise a catalyst, which is one or more solid acid catalysts and/or which is one or more basic metal oxides catalysts.

For example, the content of the particles of the catalytic composition is ranging from 15 wt. % to 90 wt. % of the particles of the bed, more preferably from 20 wt. % to 85 wt. %, even more preferably from 25 wt. % to 80 wt. % and most preferably from 30 wt. % to 75 wt. %.

For example, the one or more solid acid catalysts have a surface area ranging between 50 m²/g and 800 m²/g as determined by N₂ sorption measurements, preferably between 100 m²/g and 750 m²/g, more preferably between 150 m²/g and 700 m²/g.

For example, the one or more solid acid catalysts are one or more oxides. With preference, said one or more oxides are one or more oxides selected from γ-Al₂O₃, β-Al₂O₃, η-Al₂O₃, δ-Al₂O₃, amorphous chlorine-containing alumina, fluorine-containing alumina, phosphorus-containing alumina, ZrO₂, acid-treated zirconia, acid-treated titania, niobium oxide, tungsten oxide or any combinations thereof.

For example, the one or more solid acid catalysts are one or more mixed oxides. With preference, the one or more mixed oxides are selected from SiO₂—Al₂O₃, SiO₂—TiO₂, SiO₂—SnO₂, SiO₂—ZrO₂, SiO₂—BeO, SiO₂—MgO, SiO₂—CaO, SiO₂—SrO, SiO₂—ZnO, SiO₂—Ga₂O₃, SiO₂—Y₂O₃, SiO₂—La₂O₃, SiO₂—WO₃, SiO₂—ThO₂, Al₂O₃—MgO, Al₂O₃—ZnO, Al₂O₃—ThO₂, Al₂O₃—TiO₂, Al₂O₃—ZrO₂, Al₂O₃—MoO₃, Al₂O₃—WO₃, Al₂O₃—Cr₂O₃, Al₂O₃—Mn₂O₃, Al₂O₃—Fe₂O₃, TiO₂—MgO, TiO₂—ZnO, TiO₂—ZrO₂, TiO₂—SnO₂, TiO₂—Sb₂O₅, TiO₂—V₂O₅, TiO₂—Cr₂O₃, TiO₂—MoO₃, TiO₂—WO₃, WO₃—SnO₂, WO₃—ZrO₂, Nb₂O₅—Al₂O₃, Nb₂O₅—WO₃, Nb₂O₅—MoO₃, Nb₂O₅—ZrO₂, Nb₂O₅—TiO₂, TiO₂—Fe₂O₃ and any combinations thereof.

For example, the one or more solid acid catalysts are one or more phosphates. With preference, said one or more phosphates are one or more phosphates selected from titanium phosphate, zirconium phosphate, iron phosphate or any combinations thereof.

For example, the one or more solid acid catalysts are one or more zeolites selected from the group of zeolites having at least one 10-membered ring. With preference, the one or more zeolites selected from the group of zeolites having at least one 10-membered rings are one or more zeolites selected from FAU, MFI, MEL, MOR, FER, MTT, MWW, TON, EUO, HEU, MFS, and MRE families, beta zeolite, and any combinations thereof. FAU zeolites include zeolite Y, USY and are typically used in Fluid catalytic cracking of heavy gasoils in refineries.

For example, the one or more solid acid catalysts are one or more zeolites having a Si/Al ratio of at least 10 as determined by X-Ray fluorescence spectroscopy

For example, the one or more solid acid catalysts are one or more silicoaluminophosphate molecular sieves selected from the group of FAU, AEI, CHA and AEL families, and any combinations thereof.

The solid acid catalyst can be doped with metals, such as gallium, molybdenum, nickel, cobalt, zinc, iron, phosphorus or combinations thereof.

For example, the one or more basic metal oxides catalysts have a surface area ranging between 5 m²/g and 800 m²/g as determined by N₂ sorption measurements, preferably between 20 m²/g and 600 m²/g, more preferably between 50 m²/g and 500 m²/g.

For example, the one or more basic metal oxides catalysts comprise oxides and/or hydroxides from alkali, alkaline earth metals, iron, zinc or lanthanides and mixtures thereof.

It should be understood that the biomass and/or plastic feedstock can contain components that are catalyst or precursors for catalyst and that such components can be mixed with the char produced during the pyrolysis and help to catalyse the pyrolysis.

The biomass and/or waste plastic feedstock for the present process is selected from biomass and/or plastic waste.

For example, the fluid stream provided in step b) comprises a dilution stream, such as vaporized water (steam), carbon dioxide, carbon monoxide, hydrogen, methane, nitrogen or mixtures thereof or a recycle gaseous stream that is one of the products of the pyrolysis step

For example, the one or more pyrolysis products of the reaction, optionally recovered at step (d), are one or more pyrolysis gases, one or more pyrolysis oils, one or more pyrolysis chars or any combination thereof. With preference, the one or more pyrolysis oils are in vapour phase. In particular, the one or more pyrolysis products comprise one or more of non-condensable compounds and/or one or more condensable compounds. For example, the one or more non-condensable compounds are selected from nitrogen-containing gases (such as ammonia), sulphur-containing gases, halogen-containing gases, carbon dioxide, carbon monoxide, hydrogen, methane, ethane, ethylene, propane, propylene, butenes, butanes, nitrogen or any mixtures thereof. For example, the one or more condensable compounds are selected from water, one or more water-soluble metal compounds, one or more water-soluble halogen compounds, pyrolysis oil having a boiling range from 15° C. to 600° C., or any mixtures thereof. With preference, the one or more condensable compounds are in vapour phase.

In a preferred embodiment, the residence time of the vapor of the biomass and/or waste plastic feedstock in the fluidised bed section of the reactor where the temperature is between 400° C. and 900° C., range from 0.01 to 50 seconds, preferably 0.02 to 25 seconds. It should be understood that as the biomass and/or plastic waste are pyrolyzed, certain vaporized compounds might have a shorter residence time than the remaining solid.

In a preferred embodiment, the reactor outlet pressure may range from 0.1 to 1.0 MPa, preferably from 0.12 to 0.5 MPa, more preferably may be about 0.15 MPa.

For example, the step of heating the fluidized bed and/or the spouted bed is performed by passing an electric current at a voltage of at most 300 V through respectively the fluidized bed or the spouted bed, preferably at most 200 V, more preferably at most 150 V, even more preferably at most 120 V, most preferably at most 100 V, even most preferably at most 90 V.

For example, said process comprises a step of pre-heating with a gaseous stream said fluidized bed reactor and/or said spouted bed reactor before conducting said endothermic pyrolysis reaction of biomass and/or waste plastic in respectively the fluidized bed reactor and/or the spouted bed reactor; with preference, said gaseous stream is a stream of inert gas and/or has a temperature comprised between 200° C. and 500° C.

For example, wherein the at least one fluidized bed reactor and/or the at least one spouted bed reactor provided in step a) comprise a heating zone and a reaction zone and wherein the fluid stream provided in step b) is provided to the heating zone and comprises fluidisation gases, the step c) of heating respectively the fluidized bed and/or the spouted bed to a temperature ranging from 400° C. to 900° C. to conduct the endothermic pyrolysis reaction of a biomass and/or plastic feedstock into one or more pyrolysis products, comprises the following sub-steps:
heating respectively the fluidized bed and/or the spouted bed to a temperature ranging from 400° C. to 900° C. by passing an electric current through the heating zone of respectively the at least one fluidized bed or the at least one spouted bed,
transporting the heated particles from the heating zone to the reaction zone,
in the reaction zone, putting the heated particles in a fluidized state by passing upwardly through the said bed of the reaction zone a fluid stream comprising fluidisation gases, to obtain a fluidized bed or a spouted bed and to conduct the endothermic pyrolysis reaction of a biomass and/or plastic feedstock into one or more pyrolysis products,
optionally, recovering the particles from the reaction zone and recycling them to the heating zone.

The fluid stream may be a gaseous stream and/or a vaporized stream.

Step c) provides that the pyrolysis reaction is performed on a biomass and/or plastic feedstock which implies that a biomass and/or plastic feedstock is provided.

For example, wherein the heating zone and the reaction zone are mixed (i.e., the same zone); the fluid stream provided in step b) comprises a biomass and/or plastic feedstock.

For example, wherein the heating zone and the reaction zone are separated zones, the fluid stream provided in step b) to the heating zone is devoid of a biomass and/or plastic feedstock. For example, wherein the process comprises providing at least one bed reactor selected from a fluidized bed reactor or a spouted bed reactor, said at least one bed reactor being a heating zone, and at least one additional bed reactor selected respectively from a fluidized bed reactor or a spouted bed reactor, said at least one additional bed reactor being a reaction zone, the fluid stream provided in step b) to the heating zone is devoid of a biomass and/or plastic feedstock and the fluid stream provided in step b) to the reaction zone comprises a biomass and/or plastic feedstock.

It is understood that the biomass and/or plastic feedstock is provided to the reaction zone and that when the heating zone is separated from the reaction zone, no biomass and/or plastic feedstock is provided to the heating zone. It is understood that in addition to the biomass and/or plastic feedstock provided to the reaction zone, the fluidisation gas can be provided to the reaction zone.

According to a second aspect, the disclosure provides an installation to perform an endothermic pyrolysis reaction of biomass and/or waste plastic, according to the first aspect, said installation comprises at least one bed reactor selected from a fluidized bed reactor a spouted bed reactor or an arrangement between a fluidized bed reactor and a spouted bed reactor, said at least one bed reactor comprising:
at least two electrodes; with preference, one electrode is a submerged central electrode or two electrodes are submerged electrodes,
a reactor vessel;
one or more fluid nozzles for the introduction of a fluidizing gas and/or of a biomass and/or waste plastic feedstock within respectively at least one fluidized bed reactor or at least one spouted bed reactor; and
a bed comprising particles;
   the installation is remarkable in that the particles of the bed comprise at least electrically conductive particles and in that at least 10 wt. % of the particles of the bed based on the total weight of the particle of the bed are electrically conductive, have a resistivity ranging from 0.001 Ohm·cm to 500 Ohm·cm at a temperature of 600° C.

In particular, the disclosure provides an installation to perform an endothermic pyrolysis reaction of biomass and/or waste plastic according to the first aspect, said installation comprises
an electrified fluidized bed unit and/or an electrified spouted bed unit with respectively at least one fluidized bed reactor or at least one spouted bed reactor comprising:
   at least two electrodes; with preference, one electrode is a submerged central electrode or two electrodes are submerged electrodes,
   a reactor vessel;
   one or more fluid nozzles for the introduction of a fluidizing gas and/or of a biomass and/or waste plastic feedstock within respectively said fluidized bed reactor or said spouted bed reactor; and
   a bed comprising particles;
a product separation unit being downstream of respectively said electrified fluidized bed unit or said electrified spouted bed unit, the product separation unit comprising a separator vessel being in fluid contact with respectively the top of the fluidized bed reactor or the top of the spouted bed reactor of respectively the electrified fluidized bed unit or the electrified spouted bed unit; the separator vessel comprising at his top a vaporous outlet and at his bottom a solid outlet;
   the installation is remarkable in that the particles of the bed comprise at least electrically conductive particles and in that at least 10 wt. % of the particles of the bed based on the total weight of the particle of the bed are electrically conductive, have a resistivity ranging from 0.001 Ohm·cm to 500 Ohm·cm at a temperature of 600° C.

The one or more pyrolysis gases and/or the one or more non-condensable compounds and/or the one or more condensable compounds in vapour phase and/or the one or more pyrolysis oils in vapour phase exit the separator vessel through a vaporous outlet arranged at the top of the separator vessel.

The one or more pyrolysis chars exit the separator vessel through the solid outlet arranged at the bottom of the separator vessel. Optionally, the installation further comprises a recycling line to recycle the one or more pyrolysis chars exiting a solid outlet of the separator vessel to the fluidized bed reactor and/or the spouted bed reactor of respectively the electrified fluidized bed unit and/or the electrified spouted bed unit.

With preference, the at least two electrodes of respectively the fluidized bed reactor or of the spouted bed reactor of respectively the electrified fluidized bed unit or the electrified spouted bed unit comprise or are made of tantalum.

For example, the electrically conductive particles are or comprise one or more selected from one or more metallic alloys, one or more non-metallic resistors, one or more metallic carbides, one or more metallic nitrides, one or more metallic phosphides, one or more carbon-containing particles, one or more superionic conductors, one or more phosphate electrolytes, one or more mixed oxides being doped with one or more lower-valent cations, one or more mixed sulphides being doped with one or more lower-valent cations, and any mixture thereof.

For example, the electrically conductive particles are or comprise one or more selected from one or more metallic alloys, one or more non-metallic resistors, one or more metallic carbides, one or more metallic nitrides, one or more metallic phosphides, graphite, carbon black, char, charcoal, one or more superionic conductors, one or more phosphate electrolytes, one or more mixed oxides being doped with one or more lower-valent cations, one or more mixed sulphides being doped with one or more lower-valent cations, and any mixture thereof.

Advantageously, the at least one fluidized bed reactor and/or the at least one spouted bed reactor are devoid of heating means. For example, the at least one fluidized bed reactor and/or the at least one spouted bed reactor are devoid of heating means located around or inside the reactor vessel. For example, all the fluidized bed reactors and/or all the spouted bed reactors are devoid of heating means. When stating that at least one of the fluidized and/or the spouted bed reactors is devoid of “heating means”, it refers to “classical” heating means, such as ovens, gas burners, hot plates and the like. There are no other heating means than the at least two electrodes of respectively the fluidized bed reactor and/or the spouted bed reactor itself. For example, the at least one fluidized bed reactor and/or the at least one spouted bed reactor are devoid of heating means selected from ovens, gas burners, hot plates, or any combination thereof. For example, all the fluidized bed reactors and/or the spouted bed reactors are devoid of heating means selected from ovens, gas burners, hot plates, or any combination thereof.

In a preferred embodiment, the at least one fluidized bed reactor and/or the at least one spouted bed reactor comprising at least two electrodes and a bed comprising particles are devoid of packing.

For example, the fluidizing gas is one or more diluent gases or recycled pyrolysis gases or combination thereof.

For example, the at least one fluidized bed reactor vessel has an inner diameter of at least 100 cm, preferably at least 200 cm, more preferably at least 300 cm.

For example, the at least one spouted bed reactor vessel has an inner diameter at the bottom inlet of the one or more spouts of at least 5 mm, preferably at least 10 mm, more preferably at least 12 mm and/or has an inner diameter after the conical section of at least 100 mm, preferably at least 200 mm, more preferably at least 300 mm.

With preference, the reactor vessel comprises a reactor wall made of materials that are corrosion-resistant materials and advantageously said reactor wall materials comprise nickel (Ni), SiAlON ceramics, yttria-stabilized zirconia (YSZ), tetragonal polycrystalline zirconia (TZP) and/or tetragonal zirconia polycrystal (TPZ).

With preference, one of the electrodes is the reactor vessel or the gas distributor and/or said at least two electrodes are made in stainless steel material or nickel-chromium alloys or nickel-chromium-iron alloys.

For example, the at least one fluidized bed reactor and/or the at least one spouted bed reactor comprise a heating zone and a reaction zone, one or more fluid nozzles to provide a biomass and/or waste plastic feedstock to the reaction zone, and optional means to transport the particles of the bed from the reaction zone back to the heating zone.

For example, the installation comprises at least two fluidized bed reactors connected one to each other wherein at least one reactor of said at least two fluidized bed reactor is the heating zone and at least another reactor of said at least two fluidized bed reactor is the reaction zone. With preference, the installation comprises one or more fluid nozzles arranged to inject a biomass and/or waste plastic feedstock to the at least one bed reactor being the reaction zone; means to transport the particles of the bed from the heating zone to the reaction zone when necessary; and optional means to transport the particles from the reaction zone back to the heating zone. This configuration is remarkable in that a given particle bed is common to respectively at least two fluidized bed reactor.

For example, the installation comprises at least two spouted bed connected one to each other wherein at least one reactor of said at least two spouted bed reactors is the heating zone and at least another reactor of said at least two spouted bed reactors is the reaction zone. With preference, the installation comprises one or more fluid nozzles arranged to inject a biomass and/or waste plastic feedstock to the bed reactor being the reaction zone; means to transport the particles of the bed from the heating zone to the reaction zone when necessary; and optional means to transport the particles from the reaction zone back to the heating zone. This configuration is remarkable in that a given particle bed is common to at least two spouted bed reactors.

Advantageously, said installation comprises an electrified fluidized bed unit and an electrified spouted bed unit, wherein at least one fluidized bed reactor of the electrified fluidized bed unit is connected to at least one spouted bed reactor of the electrified spouted bed unit, wherein said at least one fluidized bed reactor is the heating zone and said at least spouted bed reactor is the reaction zone.

It is thus preferred that the installation comprises at least one fluidized bed reactor connected to at least spouted bed reactor, wherein said at least one fluidized bed reactor is the heating zone and said at least spouted bed reactor is the reaction zone. With preference, the installation comprises one or more fluid nozzles arranged to inject a biomass and/or waste plastic feedstock to the bed reactor of the spouted bed reactor; means to transport the particles of the bed from the heating zone to the reaction zone when necessary; and optional means to transport the particles from the reaction zone back to the heating zone. Indeed, the pyrolysis of the biomass and/or waste plastic feedstock works better in this configuration.

For example, the at least one fluidized bed reactor and/or the at least one spouted bed reactor are respectively a single fluidized bed reactor and/or a single spouted bed reactor, wherein the heating zone is the bottom part of respectively the fluidized bed reactor and/or the spouted bed reactor while the reaction zone is the top part of respectively the fluidised bed reactor and/or the spouted bed reactor. With preference, the installation comprises one or more fluid nozzles to inject a biomass and/or waste plastic feedstock between the two zones. The diameter of the heating zone and reaction zone can be different to accomplish optimum conditions for heating in the bottom zone and optimum conditions for biomass and/or waste plastic conversion in the top zone. Particles can move from the heating zone to the reaction zone by entrainment and the other way around from the reaction zone back to the heating zone by gravity. Optionally, particles can be collected from the upper heating zone and transferred by a separate transfer line back to the bottom heating zone.

For example, the at least one fluidized bed and/or the at least one spouted bed comprise at least two lateral zones being an outer zone and an inner zone wherein the outer zone is surrounding the inner zone, with the outer zone being the heating zone and the inner zone being the reaction zone. In a less preferred configuration, the outer zone is the reaction zone and the inner zone is the heating zone. With preference, the installation comprises one or more fluid nozzles to inject a biomass and/or waste plastic feedstock in the reaction zone.

In an embodiment, from 50 wt. % to 100 wt. % of the electrically conductive particles of the bed based on the total weight of the electrically conductive particles of the bed are one or more selected from graphite, carbon black, one or more metallic alloys, one or more non-metallic resistors, one or more metallic carbides, one or more metallic nitrides, one or more metallic phosphides, graphite, carbon black, char, charcoal, coke, petroleum coke, one or more superionic conductors, one or more phosphate electrolytes, one or more mixed oxides being doped with one or more lower-valent cations, one or more mixed sulphides being doped with one or more lower-valent cations, and any mixture thereof; preferably, from 60 wt. % to 100 wt. %; more preferably from 70 wt. % to 100 wt. %; even more preferably from 80 wt. % to 100 wt. % and most preferably from 90 wt. % to 100 wt. %.

According to a third aspect, the disclosure provides the use of a bed comprising particles in at least one fluidized bed reactor or in at least one spouted bed reactor to perform a process of an endothermic pyrolysis reaction of a biomass and/or waste plastic according to the first aspect, the use is remarkable in that the particles of the bed comprise at least electrically conductive particles and in at least 10 wt. % of the particles of the bed based on the total weight of the particles of the bed are electrically conductive and have a resistivity ranging from 0.001 Ohm·cm to 500 Ohm·cm at a temperature of 600° C.

For example, the electrically conductive particles are or comprise one or more selected from one or more metallic alloys, one or more non-metallic resistors, one or more metallic carbides, one or more metallic nitrides, one or more metallic phosphides, one or more carbon-containing particles, one or more superionic conductors, one or more phosphate electrolytes, one or more mixed oxides being doped with one or more lower-valent cations, one or more mixed sulphides being doped with one or more lower-valent cations, and any mixture thereof.

For example, the electrically conductive particles are or comprise one or more selected from one or more metallic alloys, one or more non-metallic resistors, one or more metallic carbides, one or more metallic nitrides, one or more metallic phosphides, graphite, carbon black, char, charcoal, coke, petroleum coke, one or more superionic conductors, one or more phosphate electrolytes, one or more mixed oxides being doped with one or more lower-valent cations, one or more mixed sulphides being doped with one or more lower-valent cations, and any mixture thereof.

For example, the use comprises heating the bed comprising particles to a temperature ranging from 400° C. to 900° C. in a first reactor, transporting the heated particle bed from the first reactor to a second reactor and providing a biomass and/or waste plastic feedstock to the second reactor; with preference, at least the second reactor is a fluidized bed reactor or a spouted bed reactor; and/or at least the second reactor is devoid of heating means; more preferably, the first reactor and the second reactor are fluidized bed reactors or spouted bed reactor; and/or the first and the second reactor are devoid of heating means. For example, the second reactor is devoid of electrodes.

In an embodiment, from 50 wt. % to 100 wt. % of the electrically conductive particles of the bed based on the total weight of the electrically conductive particles of the bed are one or more selected from graphite, carbon black, one or more metallic alloys, one or more non-metallic resistors, one or more metallic carbides, one or more metallic nitrides, one or more metallic phosphides, one or more carbon-containing particles, one or more superionic conductors, one or more phosphate electrolytes, one or more mixed oxides being doped with one or more lower-valent cations, one or more mixed sulphides being doped with one or more lower-valent cations, and any mixture thereof; preferably, from 60 wt. % to 100 wt. %; more preferably from 70 wt. % to 100 wt. %; even more preferably from 80 wt. % to 100 wt. % and most preferably from 90 wt. % to 100 wt. %.

According to a fourth aspect, the disclosure provides the use of an installation comprising at least one fluidized bed reactor or at least one spouted bed reactor to perform an endothermic pyrolysis reaction of a biomass and/or waste plastic, remarkable in that the installation is according to the second aspect. With preference, the disclosure provides the use of an installation comprising at least one fluidized bed reactor or at least one spouted bed reactor to perform an endothermic pyrolysis reaction of a biomass and/or waste plastic as defined in a process according to the first aspect.

The particular features, structures, characteristics or embodiments may be combined in any suitable manner, as would be apparent to a person skilled in the art from this disclosure, in one or more embodiments.

### DESCRIPTION OF THE FIGURES

FIG. 1 illustrates an installation according to the prior art.

FIG. 2 illustrates an installation according to the disclosure with one fluidized bed reactor wherein the heating zone and reaction zone are the same.

FIG. 3 illustrates an installation according to the disclosure with one fluidized bed reactor wherein the heating zone and reaction zone are arranged one above the other.

FIG. 4 illustrates an installation according to the disclosure with one fluidized bed reactor wherein the heating zone and reaction zone are arranged one lateral to the other.

FIG. 5 illustrates an installation according to the disclosure with two fluidized bed reactors.

FIG. 6 illustrates an installation according to the disclosure with one spouted bed reactor.

### DETAILED DESCRIPTION

For the disclosure, the following definitions are given:

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all integer numbers and, where appropriate, fractions subsumed within that range (e.g. 1 to 5 can include 1, 2, 3, 4, 5 when referring to, for example, a number of elements, and can also include 1.5, 2, 2.75 and 3.80, when referring to, for example, measurements). The recitation of endpoints also includes the recited endpoint values themselves (e.g. from 1.0 to 5.0 includes both 1.0 and 5.0). Any numerical range recited herein is intended to include all sub-ranges subsumed therein.

Zeolite codes (e.g., CHA . . . ) are defined according to the “Atlas of Zeolite Framework Types”, 6^{th} revised edition, 2007, Elsevier, to which the present application also refers.

The Si/Al atomic ratio of a zeolite corresponds to the amount of SiO₂ divided by the amount of Al₂O₃ taking into account the fact there are two atoms of aluminium for one atom of silicon. The silicon to aluminium ratio (also stated as SAR) corresponds to the amount of SiO₂ divided by the amount of Al₂O₃ notwithstanding the proportion of the Si atoms over the Al atoms in the chemical formula of the zeolite. Therefore, the value of the SAR always corresponds to twice the value of the Si/Al atomic ratio.

The present disclosure provides a process to perform an endothermic pyrolysis reaction of biomass and/or waste plastic, said process comprising the steps of:
a) providing at least one bed reactor selected from a fluidized bed reactor or a spouted bed reactor, said bed reactor comprising at least two electrodes and a bed comprising particles;
b) putting the particles of the bed in a fluidized state by passing upwardly through the said bed a fluid stream, to obtain respectively a fluidized bed or a spouted bed;
c) heating respectively the fluidized bed and/or the spouted bed to a temperature ranging from 400° C. to 900° C. to conduct the endothermic pyrolysis reaction of a biomass and/or waste plastic feedstock; and
d) optionally, recovering the one or more pyrolysis products of the reaction;
   the process is remarkable in that the particles of the bed comprise at least electrically conductive particles and in that at least 10 wt. % of the particles based on the total weight of the particles of the bed are electrically conductive and have a resistivity ranging from 0.001 Ohm·cm to 500 Ohm·cm at of 600° C.; in that the step c) of heating respectively the fluidized bed and/or the spouted bed is performed by passing an electric current through respectively the fluidized bed and/or the spouted bed.

For example, the electrically conductive particles of the bed are or comprise one or more selected from one or more carbon-containing particles, one or more metallic alloys, one or more non-metallic resistors, one or more metallic carbides, one or more metallic nitrides, one or more metallic phosphides, one or more superionic conductors, one or more phosphate electrolytes, one or more mixed oxides being doped with one or more lower-valent cations, one or more mixed sulphides being doped with one or more lower-valent cations, and any mixture thereof.

For example, the electrically conductive particles of the bed are or comprise one or more selected from graphite, carbon black, char, charcoal, coke, petroleum coke, one or more metallic alloys, one or more non-metallic resistors, one or more metallic carbides, one or more metallic nitrides, one or more metallic phosphides, one or more superionic conductors, one or more phosphate electrolytes, one or more mixed oxides being doped with one or more lower-valent cations, one or more mixed sulphides being doped with one or more lower-valent cations, and any mixture thereof.

In an embodiment, from 50 wt. % to 100 wt. % of the electrically conductive particles of the bed based on the total weight of the electrically conductive particles of the bed are one or more selected from graphite, carbon black, char, charcoal, coke, petroleum coke, one or more metallic alloys, one or more non-metallic resistors, one or more metallic carbides, one or more metallic nitrides, one or more metallic phosphides, one or more superionic conductors, one or more phosphate electrolytes, one or more mixed oxides being doped with one or more lower-valent cations, one or more mixed sulphides being doped with one or more lower-valent cations, and any mixture thereof; preferably, from 60 wt. % to 100 wt. %; more preferably from 70 wt. % to 100 wt. %; even more preferably from 80 wt. % to 100 wt. % and most preferably from 90 wt. % to 100 wt. %.

In a preferred embodiment, from 50 wt. % to 100 wt. % of the electrically conductive particles of the bed based on the total weight of the electrically conductive particles of the bed comprise the pyrolysis char, which is one of the one or more products of the pyrolysis reaction that can either remain in the fluidized bed reactor or in the spouted bed reactor or can be recycled from the separation of the one or more pyrolysis products back respectively into the fluidized bed reactor or into the spouted bed reactor.

The fluid stream may be a gaseous stream and/or a vaporized stream.

For example, the step of heating the fluidized bed and/or the spouted bed is performed by passing an electric current at a voltage of at most 300 V through respectively the fluidized bed or the spouted bed, preferably at most 200 V, more preferably at most 150 V, even more preferably at most 120 V, most preferably at most 100 V, even most preferably at most 90 V.

The solid particulate material in the fluidized bed reactor or in the spouted bed reactor is typically supported by a porous plate, a perforated plate, a plate with nozzles or chimneys, known as a distributor. The fluid is then forced through the distributor up and travelling through the voids between the solid particulate material. At lower fluid velocities, the solids remain settled as the fluid passes through the voids in the material, known as a packed bed reactor. As the fluid velocity is increased, the particulate solids will reach a stage where the force of the fluid on the solids is enough to counterbalance the weight of the solid particulate material. This stage is known as incipient fluidization and occurs at this minimum fluidization velocity. Once this minimum velocity is surpassed, the contents of the reactor bed begin to expand and become fluidized. Depending on the operating conditions and properties of the solid phase various flow regimes can be observed in such reactors. The minimum fluidization velocity needed to achieve bed expansion depends upon the size, shape, porosity and density of the particles and the density and viscosity of the upflowing fluid.

P. R. Gunjal, V. V. Ranade, in Industrial Catalytic Processes for Fine and Specialty Chemicals, (2016) reads that four different categories of fluidization based on the mean particle have been differentiated by Geldart that determine the fluidization regimes:
type A, aeratable fluidization (medium size, medium-density particles which are easier to fluidize; Particles of typically 30-100 μm, density ˜ 1500 kg/m³);
type B, sand-like fluidization (heavier particles which are difficult to fluidize; Particles of typically 100-800 μm, density between 1500 and 4000 kg/m³);
type C, cohesive fluidization (typical powder-like solid particle fluidization; Fine-size particles (˜ 20 μm) with a dominance of intraparticle or cohesive forces); and
type D, spoutable fluidization (large density and larger particle ˜ 1-4 mm, dense and spoutable).

Fluidization may be broadly classified into two regimes (Fluid Bed Technology in Materials Processing, 1999 by CRC Press): homogeneous fluidization and heterogeneous fluidization. In homogeneous or particulate fluidization, particles are fluidized uniformly without any distinct voids. In heterogeneous or bubbling fluidization, gas bubbles devoid of solids are distinctly observable. These voids behave like bubbles in gas-liquid flows and exchange gas with the surrounding homogeneous medium with a change in size and shape while rising in the medium. In particulate fluidization, the bed expands smoothly with substantial particle movement and the bed surface is well defined. Particulate fluidization is observed only for Geldart-A type particles. A bubbling fluidization regime is observed at much higher velocities than homogeneous fluidization, in which distinguishable gas bubbles grow from the distributor, may coalesce with other bubbles and eventually burst at the surface of the bed. These bubbles intensify the mixing of solids and gases and bubble sizes tend to increase further with a rise in fluidization velocity. A slugging regime is observed when the bubble diameter increases up to the reactor diameter. In a turbulent regime, bubbles grow and start breaking up with the expansion of the bed. Under these conditions, the top surface of the bed is no longer distinguishable. In fast fluidization or pneumatic fluidization, particles are transported out of the bed and need to be recycled back into the reactor. No distinct bed surface is observed.

Fluidized bed reactors have the following advantages:

Uniform Particle Mixing: Due to the intrinsic fluid-like behaviour of the solid particulate material, fluidized beds do not experience poor mixing as in packed beds. The elimination of radial and axial concentration gradients also allows for better fluid-solid contact, which is essential for reaction efficiency and quality.

Uniform Temperature Gradients: Many chemical reactions require the addition or removal of heat. Local hot or cold spots within the reaction bed are avoided in a fluidized situation.

Ability to Operate the Reactor Continuously: The fluidized bed and/or the spouted bed nature of these reactors allows for the ability to continuously withdraw products and introduce new reactants into the reaction vessel. On top of continuous operation of the chemical reactions, the fluidized bed and/or the spouted bed also allows to continuously or at given frequency withdraw solid material or add continuously or at given frequency new fresh solid material thanks to the flowable solid particulate material.

Heat can be produced by passing an electrical current through a conducting material that has sufficiently high resistivity (the resistor) to transform electricity into heat. Electrical resistivity (also called specific electrical resistance or volume resistivity, is an intrinsic property independent of shape and size) and its inverse, electrical conductivity, is a fundamental property of a material that quantifies how strongly it resists or conducts electric current (SI unit of electrical resistivity is the ohm-meter (Ω·m) and for conductivity Siemens per meter (S/m)).

When electricity is passed through a fixed bed of electrically conducting particulate solids, having a sufficient resistivity, the bed offers resistance to the flow of current; this resistance depends on many parameters, including the nature of the solid, the nature of the linkages among the particles within the bed, the bed voidage, the bed height, the electrode geometry, etc. If the same fixed bed is fluidized by passing gas, the resistance of the bed increases; the resistance offered by the conducting particles generates heat within the bed and can maintain the bed in isothermal conditions (termed an electrothermal fluidized bed or electrofluid reactor). In many high-temperature reactions, electrofluid reactors offer in situ heating during the reaction and are particularly useful for operating endothermic reactions and hence save energy because no external heating or transfer of heat is required. It is a prerequisite that at least part of the solid particulate material is electrically conducting but non-conducting solid particulates can be mixed and still result in enough heat generation. Such non-conducting or very high resistivity solids can play a catalytic role in the chemical conversion. The characteristics of the bed material determine the resistance of an electrothermal fluidized bed furnace; as this is a charge resistor type of heat generation, the specific resistivity of the particles affects the bed resistance. The size, shape, composition, and size distribution of the particles also influence the magnitude of the bed resistance. Also, when the bed is fluidized, the voids generated between the particles increases the bed resistance. The total resistance of the bed is the sum of two components, e.g., the electrode contact-resistance (i.e., the resistance between the electrode and the bed) and the bed resistance. A large contact-resistance will cause extensive local heating in the vicinity of the electrode while the rest of the bed stays rather cool. The following factors determine the contact-resistance: current density, fluidization velocity, type of bed material, electrode size and the type of material used for the electrodes. The electrode compositions can be advantageously metallic like iron, cast iron or other steel alloys, copper or a copper-based alloy, nickel or a nickel-based alloy or refractory like metal, intermetallics or an alloy of Zr, Hf, V, Nb, Ta, Cr, Mo, W or ceramic-like carbides, nitrides or carbon-based like graphite. The area of contact between the bed material and the electrodes can be adjusted, depending on the electrode submergence and the amount of particulate material in the fluidized bed or the spouted bed. Hence, the electrical resistance and the power level can be manipulated by adjusting these variables. Advantageously, to prevent overheating of the electrodes compared to the non-electrified fluidised bed or spouted bed, the resistivity of the electrode should be lower (and hence the joule heating) than of the particulate material of respectively the fluidized bed or the spouted bed. In a preferred embodiment, the electrodes can be cooled by passing a colder fluid inside or outside the electrodes. Such fluids can be any liquid that vaporises upon a heating, gas stream or can be a part of the colder feedstock that first cools the electrode before entering the fluidised bed or the spouted bed.

The spouted bed reactor is an alternative technology to classical fluidized bed reactor for handling sticky and irregular materials (broad particle size distribution). Vigorous cyclic particle movement in spouted beds, results in high isothermicity, with a high heat transfer between phases, which is essential for the treatment of low conductivity material such as plastics and finally the short residence time of volatiles requires less fluidisation gas. The reactor volume is lower than in fluidized beds for the same capacity and no distributor plate is required. In particular, conical spouted bed reactors have been proposed for biomass pyrolysis (Fuel Processing Technology, Volume 112, August 2013, Pages 48-56) as well as for plastic pyrolysis (in Pyrolysis, Chapter12: Pyrolysis of Polyolefins in a Conical Spouted Bed Reactor: A Way to Obtain Valuable Products, 2017). The spouted bed reactor is a bed reactor with a carrier fluidisation gas introduced to fluidise the bed material and is preferably a conical spouted bed reactor.

The spouted bed reactor is a particular version of fluidized bed reactor and is a combination of a jet-like upward-moving dilute fluidized phase (spout) surrounded by a slow downwards falling bed (annulus) through which gas percolates upward (Scaleup, slot-rectangular, and multiple spouting. Spouted and Spout-Fluid Beds, 283-296. doi: 10.1017/cbo9780511777936.018). Spouted bed is gas-solid contactor in which a high velocity gas stream is introduced through a single orifice from the centre of the base (bottom), resulting in a cyclic pattern of solid movement inside the bed. A spouted bed has three different regions: the spout (A), the fountain (B) and the annulus (C) (see on FIG. 6). At stable spouting conditions, a spout appears at the centre of the bed, a fountain appears above the bed surface and an annulus forms between the spout and the wall. At stable spouting conditions, spout and fountain are similar to fluidized beds where particles are dynamically suspended. The annulus region is more like a falling bed with down flow of particles along the bed walls. Particles enter the spout radially at the bottom and leave at the top in the fountain region and subsequently move downward in the annulus to enter the spout for the next circulation cycle.

A typical configuration is the conical cylindrical reactors with one central spout inlet at the base from where the vessel diameter diverges to the maximum diameter of the bed with axial symmetry between the spout and the annulus. Larger capacities can be designed with slot-rectangular reactors in which planar symmetry replaces axial symmetry. Two facing walls are completely vertical and flat, whereas the other two are vertical, with a converging sloping lower section (funnel) where through an open slot at the bottom the fluidization gas enters. The capacity can hence be increased by extending the distance of the flat walls and the length of the slot. These configurations are commonly referred to as two-dimensional spouted beds. Alternatively, for large scale up applications the spouted beds can be provided with multiple discrete entry points (multiple spouts) for the incoming spouting gas, essentially dividing the overall system into modular spouted beds in parallel. The multiple entry points can be fed from a common plenum chamber or “windbox,” or each entry point may be connected separately to a common fluidization gas supply. The overall vessel can be rectangular or cylindrical.

Spouted bed reactors can be equipped with draft tubes and such internal configuration aids performance because better control of the fluid residence time and solid cycle time distributions is possible. The draft tube starts at a distance above the inlet spout nozzle of the fluidization gas leaving an opening through which particles from the annulus are entrained into the draft tube and stops near the start of the fountain.

Often in spouted beds with one central opening or slot, formation of dead zones near the bottom can result in reduced mixing and particle movement in the annulus. This can be reduced in so-called spout fluidized bed or spout-fluid bed. In these reactor beds, additional background gas (also known as auxiliary or fluidizing gas) is supplied through the bottom (flat, conical or funnel) through openings surrounding the main spout inlet. This additional background gas flow leads to higher circulation and mixing rates, due to the bubble generation in the annulus, leading enhanced particle movement in vertical and radial directions. The total flow rate required to fluidize particles is lower in comparison to fluidized and spouted beds. In spout fluidized beds wider flow rates can be used with a lower tendency to slugging which is important specifically for particles with varying size and density.

Bed resistance can be predicted by the ohmic law. The mechanism of current transfer in fluidized beds is believed to occur through current flow along continuous chains of conducting particles at low operating voltages. At high voltages, a current transfer occurs through a combination of chains of conducting particles and arcing between the electrode and the bed as well as particle-to-particle arcing that might ionize the gas, thereby bringing down the bed resistance. Arcing inside the bed, in principle, is not desirable as it would lower the electrical and thermal efficiency. The gas velocity impacts strongly the bed resistance, a sharp increase in resistance from the settled bed onward when the gas flow rate is increased; a maximum occurred close to the incipient fluidization velocity, followed by a decrease at higher velocities. At gas flow rates sufficient to initiate slugging, the resistance again increased. Average particle size and shape impact resistance as they influence the contacts points between particles. In general, the bed resistivity increases 2 to 5 times from a settled bed (e.g. 20 Ohm·cm for graphite) to the incipient fluidisation (60 Ohm·cm for graphite) and 10 to 40 times from a settled bed to twice (300 Ohm·cm for graphite) the incipient fluidisation velocity. Non or less-conducting particles can be added to conducting particles. If the conducting solid fraction is small, the resistivity of the bed would increase due to the breaking of the linkages in the chain of conducting solids between the electrodes. If the non-conducting solid fraction is finer in size, it would fill up the interstitial gaps or voidage of the larger conducting solids and hence increase the resistance of the bed.

In general, for a desired high heating power, a high current at a low voltage is preferred. The power source can be either AC or DC. Voltages applied in an electrothermal fluidized bed are typically below 100 V to reach enough heating power. The electrothermal fluidized bed can be controlled in the following three ways:

1. Adjusting the gas flow: Because the conductivity of the bed depends on the extent of voidage or gas bubbles inside the bed, any variation in the gas flow rate would change the power level; hence the temperature can be controlled by adjusting the fluidizing gas flow rate. The flow rate required for optimum performance corresponds to a velocity which equals or slightly exceeds the minimum fluidization velocity.

2. Adjusting the electrode submergence: The power level can also be controlled by varying the electrode immersion level inside the bed because the conductivity of the bed is dependent on the area of contact between the conducting particles and the electrode: the surface area of the electrode available for current flow increases with electrode submergence, leading to a reduction in overall resistance.

3. Adjusting the applied voltage: although changing the power level by using the first two methods is often more affordable or economical than increasing the applied voltage, however in electrothermal fluidized beds three variables are available to control the produced heating power.

The wall of the reactor is generally made of graphite, ceramics (like SiC), high-melting metals or alloys as it is versatile and compatible with many high-temperature reactions of industrial interest. The atmosphere for the reaction is often restricted to the neutral or the reducing type as an oxidising atmosphere can combust carbon materials or create a non-conducting metal oxide layer on top of metals or alloys. The wall and/or the distribution plate itself can act as an electrode for the reactor. The fluidized or the spouted solids can be graphite or any other high-melting-point, electrically conducting particles. The other electrodes, which is usually immersed in the bed, can also be graphite or a high-melting-point metal, intermetallics or alloys.

It may be advantaged to generate the required reaction heat by heating the conductive particles and/or catalyst particles in a separate zone of the reactor where little or substantially no feedstock hydrocarbons are present, but only diluent gases. The benefit is that the appropriate conditions of fluidization to generate heat by passing an electrical current through a bed of conductive particles can be optimized whereas the optimal reaction conditions during hydrocarbon transformation can be selected for the other zone of the reactor. Such conditions of optimal void fraction and linear velocity might be different for heating purposes and chemical transformation purposes.

In an embodiment of the present disclosure, the installation comprises of two zones arranged in series namely a first zone being a heating zone and a second zone being a reaction zone, where the conductive particles and catalyst particles are continuously moved or transported from the first zone to the second zone and vice versa. The first and second zones can be different parts of respectively a fluidized bed or a spouted bed or can be located in separate fluidized beds reactors or in in separated spouted bed reactors connected one to each other.

In the said embodiment, the process to perform an endothermic pyrolysis reaction of biomass and/or waste plastic said process comprising the steps of:
a) providing at least one fluidized bed reactor or at least one spouted bed reactor comprising at least two electrodes and a bed comprising particles;
b) putting the particles in a fluidized state by passing upwardly through the said bed a fluid stream, to obtain a fluidized bed or a spouted bed;
c) heating respectively the fluidized bed and/or the spouted bed to a temperature ranging from 400° C. to 900° C. to conduct the endothermic pyrolysis reaction of a biomass and/or waste plastic feedstock; and
d) optionally, recovering the one or more pyrolysis products of the reaction;
   wherein the particles of the bed comprise at least electrically conductive particles and wherein at least 10 wt. % of the particles based on the total weight of the particles of the bed are electrically conductive particles, have a resistivity ranging from 0.001 Ohm·cm to 500 Ohm·cm at 600° C.; wherein the at least one fluidized bed reactor and/or the at least one spouted bed reactor provided in step a) comprise a heating zone and a reaction zone and wherein the fluid stream provided in step b) is provided to the heating zone and comprises fluidisation gases and the step c) of heating respectively the fluidized bed and/or the spouted bed to a temperature ranging from 400° C. to 900° C. to conduct the endothermic pyrolysis reaction of a biomass and/or waste plastic feedstock into one or more pyrolysis products, comprises the following sub-steps:
heating respectively the fluidized bed and/or the spouted bed to a temperature ranging from 400° C. to 900° C. by passing an electric current through the heating zone of respectively the at least one fluidized bed or the at least one spouted bed,
transporting the heated particles from the heating zone to the reaction zone,
in the reaction zone, putting the heated particles in a fluidized state by passing upwardly through the said bed of the reaction zone a fluid stream comprising fluidisation gases, to obtain respectively a fluidized bed or a spouted bed and to conduct the endothermic pyrolysis reaction of a biomass and/or waste plastic feedstock into one or more pyrolysis product,
optionally, recovering the particles from the reaction zone and recycling them to the heating zone.

For example, the electrically conductive particles are or comprise one or more selected from one or more metallic alloys, one or more non-metallic resistors, one or more metallic carbides, one or more metallic nitrides, one or more metallic phosphides, one or more carbon containing particles, one or more superionic conductors, one or more phosphate electrolytes, one or more mixed oxides being doped with one or more lower-valent cations, one or more mixed sulphides being doped with one or more lower-valent cations, and/or any mixture thereof,

For example, the electrically conductive particles are or comprise one or more selected from one or more metallic alloys, one or more non-metallic resistors, one or more metallic carbides, one or more metallic nitrides, one or more metallic phosphides, graphite, carbon black, char, charcoal, coke, petroleum coke, one or more superionic conductors, one or more phosphate electrolytes, one or more mixed oxides being doped with one or more lower-valent cations, one or more mixed sulphides being doped with one or more lower-valent cations, and/or any mixture thereof,

For example, the fluidisation gases can be one or more selected from steam, hydrogen, carbon dioxide, argon, helium, nitrogen, methane, recycled pyrolysis gases or combination thereof.

The fluid stream may be a gaseous stream and/or a vaporized stream.

For example, the at least one fluidized bed reactor and/or the at least one spouted bed reactor are respectively at least two fluidized bed reactors or at least two spouted bed reactors connected one to each other wherein at least one of said at least two fluidized bed reactors or at least one of said at least two spouted bed reactor is the heating zone and at least another of respectively said at least two fluidized bed reactors or of said at least two spouted bed reactor is the reaction zone. With preference, the at least one fluidized bed reactor and/or the at least one spouted bed reactor being the heating zone comprise gravitational or pneumatic transport means to transport the particles from the heating zone to the reaction zone and/or the installation comprises means arranged to inject a biomass and/or waste plastic feedstock to respectively the at least one bed reactor selected from a fluidized bed reactor spouted bed reactor, said at least one bed reactor being the reaction zone. The installation is devoid of means to inject a biomass and/or waste plastic feedstock to the at least one bed reactor selected from a fluidized bed reactor or a spouted bed reactor, said one bed reactor being the heating zone.

For example, the at least one fluidized bed reactor and/or the at least one spouted bed reactor are respectively a single fluidized bed reactor and/or a single spouted bed reactor, wherein the heating zone is the bottom part of respectively the fluidized bed reactor and/or the spouted bed reactor while the reaction zone is the top part of respectively the fluidised bed reactor and/or the spouted bed reactor. With preference, the installation comprises means to inject a biomass and/or waste plastic feedstock and/or diluent between the two zones. The diameter of the heating zone and reaction zone can be different in order to accomplish optimum conditions for heating in the bottom zone and optimum conditions for hydrocarbon conversion in the top zone. Particles can move from the heating zone to the reaction zone by entrainment and the other way around from the reaction zone back to the heating zone by gravity. Optionally, particles can be collected from the upper heating zone and transferred by a separate transfer line back to the bottom heating zone.

Step c) provides that the endothermic pyrolysis reaction is performed on a biomass and/or waste plastic feedstock which implies that a biomass and/or waste plastic feedstock is provided. It is understood that the biomass and/or waste plastic feedstock is provided to the reaction zone and that when the heating zone is separated from the reaction zone then, with preference, no biomass and/or waste plastic feedstock is provided to the heating zone. It is understood that in addition to the biomass and/or waste plastic feedstock provided to the reaction zone, fluidisation gases can be provided to the reaction zone. When the heating zone and the reaction zone are mixed (i.e., the same zone); the fluid stream provided in step b) comprises a fluidisation gas.

### The Bed Comprising Particles

To achieve the required temperature necessary to carry out the endothermic pyrolysis reaction, the particles of the bed comprise at least electrically conductive particles and at least 10 wt. % of the particles based on the total weight of the particles of the bed are electrically conductive, have a resistivity ranging from 0.001 Ohm·cm to 500 Ohm·cm at 600° C.

For example, the electrically particles of the bed are or comprise one or more selected from one or more metallic alloys, one or more non-metallic resistors, one or more metallic carbides, one or more metallic nitrides, one or more metallic phosphides, one or more carbon containing particles, one or more superionic conductors, one or more phosphate electrolytes, one or more mixed oxides being doped with one or more lower-valent cations, one or more mixed sulphides being doped with one or more lower-valent cations, and any mixture thereof.

For example, the electrically particles of the bed are or comprise one or more selected from one or more metallic alloys, one or more non-metallic resistors, one or more metallic carbides, one or more metallic nitrides, one or more metallic phosphides, graphite, carbon black, char, charcoal, coke, petroleum coke, one or more superionic conductors, one or more phosphate electrolytes, one or more mixed oxides being doped with one or more lower-valent cations, one or more mixed sulphides being doped with one or more lower-valent cations, and any mixture thereof.

For example, from 50 wt. % to 100 wt. % of the electrically conductive particles of the bed based on the total weight of the electrically conductive particles of the bed are one or more selected from graphite, carbon black, char, charcoal, coke, petroleum coke, one or more metallic alloys, one or more non-metallic resistors, one or more metallic carbides, one or more metallic nitrides, one or more metallic phosphides, one or more superionic conductors, one or more phosphate electrolytes, one or more mixed oxides being doped with one or more lower-valent cations, one or more mixed sulphides being doped with one or more lower-valent cations, and any mixture thereof; preferably, from 60 wt. % to 100 wt. %; more preferably from 70 wt. % to 100 wt. %; even more preferably from 80 wt. % to 100 wt. % and most preferably from 90 wt. % to 100 wt. %.

In an embodiment, from 50 wt. % to 100 wt. % of the electrically conductive particles of the bed based on the total weight of the electrically conductive particles of the bed are devoid of graphite and/or carbon black; preferably, from 60 wt. % to 95 wt. %; more preferably from 70 wt. % to 90 wt. %; and even more preferably from 75 wt. % to 85 wt. %.

For example, the content of electrically conductive particles is ranging from 10 wt. % to 100 wt. % based on the total weight of the particles of the bed; preferably, from 15 wt. % to 95 wt. %, more preferably from 20 wt. % to 90 wt. %, even more preferably from 25 wt. % to 80 wt. % and most preferably from 30 wt. % to 75 wt. %.

For example, the content of electrically conductive particles based on the total weight of the bed is at least 12 wt. % based on the total weight of the particles of the bed; preferably, at least 15 wt. %, more preferably, at least 20 wt. %; even more preferably at least 25 wt. %, and most preferably at least 30 wt. % or at least 40 wt. % or at least 50 wt. % or at least 60 wt. %.

For example, the electrically conductive particles have a resistivity ranging from 0.005 to 400 Ohm·cm at 600° C., preferably ranging from 0.01 to 300 Ohm·cm at 600° C.; more preferably ranging from 0.05 to 150 Ohm·cm at 600° C. and most preferably ranging from 0.1 to 100 Ohm·cm at 600° C.

For example, the electrically conductive particles have a resistivity of at least 0.005 Ohm·cm at 600° C.; preferably of at least 0.01 Ohm·cm at 600° C., more preferably of at least 0.05 Ohm·cm at 600° C.; even more preferably of at least 0.1 Ohm·cm at 600° C., and most preferably of at least 0.5 Ohm·cm at 600° C.

For example, the electrically conductive particles have a resistivity of at most 400 Ohm·cm at 600° C.; preferably of at most 300 Ohm·cm at 600° C., more preferably of at most 200 Ohm·cm at 600° C.; even more preferably of at most 150 Ohm·cm at 600° C., and most preferably of at most 100 Ohm·cm at 600° C.

For example, the particles of the bed have an average particle size ranging from 5 to 300 μm as determined by sieving according to ASTM D4513-11, preferably ranging from 10 to 200 μm and more preferably ranging from 30 to 150 μm.

For example, the electrically conductive particles of the bed have an average particle size ranging from 5 to 300 μm as determined by sieving according to ASTM D4513-11, preferably ranging from 10 to 200 μm and more preferably ranging from 30 to 150 μm.

The electrical resistance is measured by a four-probe DC method using an ohmmeter. A densified power sample is shaped in a cylindrical pellet that is placed between the probe electrodes. Resistivity is determined from the measured resistance value, R, by applying the known expression p=R×A/L, where L is the distance between the probe electrodes typically a few millimetres and A the electrode area.

The electrically conductive particles of the bed can exhibit electronic, ionic or mixed electronic-ionic conductivity. The ionic bonding of many refractory compounds allows for ionic diffusion and correspondingly, under the influence of an electric field and appropriate temperature conditions, ionic conduction.

The electrical conductivity, σ, the proportionality constant between the current density j and the electric field E, is given by

$$σ = j / E = Σ {c}_{i} \times {Z}_{i} q \times {μ}_{i}$$

where cᵢ is the carrier density (number/cm³), μᵢ the mobility (cm²/Vs), and Zⁱq the charge (q=1.6×10⁻¹⁹ C) of the ith charge carrier. The many orders of magnitude differences in σ between metals, semiconductors and insulators generally result from differences in c rather than μ. On the other hand, the higher conductivities of electronic versus ionic conductors are generally due to the much higher mobilities of electronic versus ionic species.

The most common materials that can be used for resistive heating is subdivided into nine groups:
(1) Metallic alloys for temperatures up to 1200-1400° C.,
(2) non-metallic resistors like silicon carbide (SiC), molybdenum disilicide (MoSi₂), nickel silicide (NiSi), sodium silicide (Na₂Si), magnesium silicide (Mg₂Si), platinum silicide (PtSi), titanium silicide (TiSi₂) and tungsten silicide (WSi₂) up to 1600-1900° C.,
(3) several mixed oxides and/or mixed sulphides being doped with one or more lower-valent cations with variable temperature optima,
(4) graphite up to 2000° C.,
(5) metallic carbides,
(6) metallic nitrides,
(7) metallic phosphides,
(8) superionic conductors, and
(9) phosphate electrolytes.

A first group of metallic alloys, for temperatures up to 1150-1250° C., can be constituted by Ni—Cr alloys with low Fe content (0.5-2.0%), preferably alloy Ni—Cr (80% Ni, 20% Cr) and (70% Ni, 30% Cr). Increasing the content of Cr increases the material resistance to oxidation at high temperatures. A second group of metallic alloys having three components are Fe—Ni—Cr alloys, with maximum operating temperature in an oxidizing atmosphere to 1050-1150° C. but which can be conveniently used in reducing atmospheres or Fe—Cr—Al (chemical composition 15-30% Cr, 2-6% Al and Fe balance) protecting against corrosion by a surface layer of oxides of Cr and Al, in oxidizing atmospheres can be used up to 1300-1400° C. Silicon carbide as non-metallic resistor can exhibit wide ranges of resistivity that can be controlled by the way they are synthesized and the presence of impurities like aluminium, iron, oxide, nitrogen or extra carbon or silicon resulting in non-stoichiometric silicon carbide. In general silicon carbide has a high resistivity at low temperature but has good resistivity in the range of 500 to 1200° C. In an alternative embodiment, the non-metallic resistor can be devoid of silicon carbide, and/or can comprise molybdenum disilicide (MoSi₂), nickel silicide (NiSi), sodium silicide (Na₂Si), magnesium silicide (Mg₂Si), platinum silicide (PtSi), titanium silicide (TiSi₂), tungsten silicide (WSi₂) or a mixture thereof.

Graphite has rather low resistivity values, with a negative temperature coefficient up to about 600° C. after which the resistivity starts to increase.

Many mixed oxides and/or mixed sulphides being doped with one or more lower-valent cations, having in general too high resistivity at low temperature, become ionic or mixed conductors at high temperature. The following circumstances can make oxides or sulphides sufficient conductors for heating purposes: ionic conduction in solids is described in terms of the creation and motion of atomic defects, notably vacancies and interstitials of which its creation and mobility is very positively dependent on temperature. Such mixed oxides or sulphides are ionic or mixed conductors, namely being doped with one or more lower-valent cations. Three mechanisms for ionic defect formation in oxides are known: (1) Thermally induced intrinsic ionic disorder (such as Schottky and Frenkel defect pairs resulting in non-stoichiometry), (2). Redox-induced defects and (3) Impurity-induced defects. The first two categories of defects are predicted from statistical thermodynamics and the latter form to satisfy electroneutrality. In the latter case, high charge carrier densities can be induced by substituting lower valent cations for the host cations. Mixed oxides and/or mixed sulphides with fluorite, pyrochlore or perovskite structure are very suitable for substitution by one or more lower-valent cations.

Several sublattice disordered oxides or sulphides have high ion transport ability at increasing temperature. These are superionic conductors, such as LiAlSiO₄, Li₁₀GeP₂S₁₂, Li_{3.6}Si_{0.6}P_{0.4}O₄, NaSICON (sodium (Na) Super Ionic CONductor) with the general formula Na₁₊ₓZr₂P₃₋ₓSiₓO₁₂ with 0<x<3, for example Na₃Zr₂PSi₂O₁₂ (x=2), or sodium beta alumina, such as NaAl₁₁O₁₇, Na_{1.6}Al₁₁O_{17.3}, and/or Na_{1.76}Li_{0.38}Al_{10.62}O₁₇.

High concentrations of ionic carriers can be induced in intrinsically insulating solids and creating high defective solids. Thus, the electrically conductive particles of the bed are or comprise one or more mixed oxides being ionic or mixed conductor, namely being doped with one or more lower-valent cations, and/or one or more mixed sulphides being ionic or mixed conductor, namely being doped with one or more lower-valent cations. With preference, the mixed oxides are selected from one or more oxides having a cubic fluorite structure being at least partially substituted with one or more lower-valent cations, preferentially selected from Sm, Gd, Y, Sc, Yb, Mg, Ca, La, Dy, Er, Eu; and/or from one or more ABO₃-perovskites with A and B tri-valent cations, being at least partially substituted in A position with one or more lower-valent cations, preferentially selected from Ca, Sr, or Mg, and comprising at least one of Ni, Ga, Co, Cr, Mn, Sc, Fe and/or a mixture thereof in B position; and/or from one or more ABO₃-perovskites with A bivalent cation and B tetra-valent cation, being at least partially substituted with one or more lower-valent cations, preferentially selected from Mg, Sc, Y, Nd or Yb in the B position or with a mixture of different B elements in the B position; and/or from one or more A₂B₂O₇-pyrochlores with A trivalent cation and B tetra-valent cation being at least partially substituted in A position with one or more lower-valent cations, preferentially selected from Ca or Mg, and comprising at least one of Sn, Zr and Ti in B position.

With preference, the one or more mixed sulphides are selected from one or more sulphides having a cubic fluorite structure being at least partially substituted with one or more lower-valent cations, preferentially selected from Sm, Gd, Y, Sc, Yb, Mg, Ca, La, Dy, Er, Eu; and/or from one or more ABS₃ structures with A and B tri-valent cations, being at least partially substituted in A position with one or more lower-valent cations, preferentially selected from Ca, Sr, or Mg, and comprising at least one of Ni, Ga, Co, Cr, Mn, Sc, Fe and/or a mixture thereof in B position; and/or from one or more ABS₃ structures with A bivalent cation and B tetra-valent cation, being at least partially substituted with one or more lower-valent cations, preferentially selected from Mg, Sc, Y, Nd or Yb in the B position or with a mixture of different B elements in the B position; and/or from one or more A₂B₂S₇ structures with A trivalent cation and B tetra-valent cation being at least partially substituted in A position with one or more lower-valent cations, preferentially selected from Ca or Mg, and comprising at least one of Sn, Zr and Ti in B position.

With preference, the degree of substitution in the one or more mixed oxides doped with one or more lower-valent cations and having a cubic fluorite structure is between 1 and 15 atom % based on the total number of atoms present in the one or more oxides or sulphides having a cubic fluorite structure, in the one or more ABO₃-perovskites with A and B tri-valent cations, in the one or more ABO₃-perovskites with A bivalent cation and B tetra-valent cation or in the one or more A₂B₂O₇-pyrochlores with A trivalent cation and B tetra-valent cation respectively, preferably between 3 and 12 atom %, more preferably between 5 and 10 atom %.

With preference, the degree of substitution in the one or more mixed oxides doped with one or more lower-valent cations is between 1 and 50 atom % based on the total number of atoms present in the one or more ABO₃-perovskites with A and B tri-valent cations, in the one or more ABO₃-perovskites with A bivalent cation and B tetra-valent cation or in the one or more A₂B₂O₇-pyrochlores with A trivalent cation and B tetra-valent cation respectively, preferably between 3 and 20 atom %, more preferably between 5 and 15 atom %.

With preference, the degree of substitution in the one or more mixed sulphides doped with one or more lower-valent cations and having a cubic fluorite structure is between 1 and 15 atom % based on the total number of atoms present in the one or more ABS₃ structures with A and B tri-valent cations, in the one or more ABS₃ structures with A bivalent cation and B tetra-valent cation or in the one or more A₂B₂S₇ structures with A trivalent cation and B tetra-valent cation respectively, preferably between 3 and 12 atom %, more preferably between 5 and 10 atom %.

With preference, the degree of substitution in the one or more mixed sulphides doped with one or more lower-valent cations is between 1 and 50 atom % based on the total number of atoms present in the one or more ABS₃ structures with A and B tri-valent cations, in the one or more ABS₃ structures with A bivalent cation and B tetra-valent cation or in the one or more A₂B₂S₇ structures with A trivalent cation and B tetra-valent cation respectively, preferably between 3 and 20 atom %, more preferably between 5 and 15 atom %.

Said one or more oxides having a cubic fluorite structure, said one or more ABO₃-perovskites with A and B tri-valent cations, said one or more ABO₃-perovskites with A bivalent cation and B tetra-valent cation or said one or more A₂B₂O₇-pyrochlores with A trivalent cation and B tetra-valent cation being at least partially substituted with lower valent cations, said one or more sulphides having a cubic fluorite structure, said one or more ABS₃ structures with A and B tri-valent cations, said one or more ABS₃ structures with A bivalent cation and B tetra-valent cation, said one or more A₂B₂S₇ structures with A trivalent cation and B tetra-valent cation being at least partially substituted with lower valent cations also means that the same element, being a high-valent cation, can be reduced in the lower-valent equivalent, for example, Ti(IV) can be reduced in Ti(III) and/or Co(III) can be reduced in Co(II) and/or Fe(III) can be reduced in Fe(II) and/or Cu(II) can be reduced in Cu(I).

Phosphate electrolytes such as LiPO₄ or LaPO₄ can also be used as electrically conductive particles.

Metallic carbides, metallic nitrides and metallic phosphides can also be selected as electrically conductive particles. For example, metallic carbides are selected from iron carbide (Fe₃C), molybdenum carbide (such as a mixture of MoC and Mo₂C). For example, said one or more metallic nitrides are selected from zirconium nitride (ZrN), tungsten nitride (such as a mixture of W₂N, WN, and WN₂), vanadium nitride (VN), tantalum nitride (TaN), and/or niobium nitride (NbN). For example, said one or more metallic phosphides are selected from copper phosphide (Cu₃P), indium phosphide (InP), gallium phosphide (GaP), sodium phosphide Na₃P), aluminium phosphide (AlP), zinc phosphide (Zn₃P₂) and/or calcium phosphide (Ca₃P₂).

It is a preferred embodiment of the present disclosure, the electrically conductive particles that exhibit only sufficiently low resistivity at a high temperature can be heated by external means before reaching the high enough temperature where resistive heating with electricity overtakes or can be mixed with a sufficiently low resistivity solid at a low temperature so that the resulting resistivity of the mixture allows to heat the fluidized bed and/or the spouted bed to the desired reaction temperature.

For example, the electrically conductive particles of the bed are or comprise silicon carbide. For example, at least 10 wt. % of the electrically conductive particles based on the total weight of the electrically conductive particles of the bed are silicon carbide particles and have a resistivity ranging from 0.001 Ohm·cm to 500 Ohm·cm at of 600° C.

In the embodiment wherein the electrically conductive particles of the bed are or comprise silicon carbide, the person skilled in the art will have the advantage to conduct a step of pre-heating with a gaseous stream said fluidized bed reactor before conduct said endothermic reaction in the fluidized bed reactor or in the spouted bed reactor. Advantageously, the gaseous stream is a stream of gas, i.e., nitrogen, argon, helium, methane, carbon dioxide, hydrogen or steam. The temperature of the gaseous stream can be at least 500° C., or at least 550° C., or at least 600° C., or at least 650° C., or at least 700° C., or at least 750° C., or at least 800° C., or at least 850° C., or at least 900° C. Advantageously, the temperature of the gaseous stream can be comprised between 500° C. and 900° C., for example between 600° C. and 800° C. or between 650° C. and 750° C. Said gaseous stream of inert gas can also be used as the fluidification gas. The pre-heating of the said gaseous stream of inert gas is performed thanks to conventional means, including using electrical energy. The temperature of the gaseous stream used for the preheating of the bed doesn't need to reach the temperature reaction.

Indeed, the resistivity of silicon carbide at ambient temperature is high, to ease the starting of the reaction, it may be useful to heat the fluidized bed and/or the spouted bed by external means, as with preference the fluidized bed reactor and/or the spouted bed reactor are devoid of heating means. Once the bed is heated at the desired temperature, the use of a hot gaseous stream may not be necessary.

However, in an embodiment, the electrically conductive particles of the bed are or comprise a mixture of silicon carbide particles and electrically conductive particles different from silicon carbide particles.

The pre-heating step may be also used in the case wherein electrically conductive particles different from silicon carbide particles are present in the bed. For example, it may be used when the content of silicon carbide in the electrically conductive particles of the bed is more than 80 wt. % based on the total weight of the particles of the bed, for example, more than 85 wt. %, for example, more than 90 wt. %, for example, more than 95 wt. %, for example, more than 98 wt. %, for example, more than 99 wt. %. However, a pre-heating step may be used whatever is the content of silicon carbide particles in the bed.

In the embodiment wherein the electrically conductive particles of the bed are or comprise a mixture of silicon carbide particles and electrically conductive particles different from silicon carbide particles, the electrically conductive particles of the bed may comprise from 10 wt. % to 99 wt. % of silicon carbide particles based on the total weight of the electrically conductive particles of the bed; preferably, from 15 wt. % to 95 wt. %, more preferably from 20 wt. % to 90 wt. %, even more preferably from 25 wt. % to 80 wt. % and most preferably from 30 wt. % to 75 wt. %.

For example, the electrically conductive particles of the bed are or comprise a mixture of silicon carbide particles and electrically conductive particles different from silicon carbide particles and the electrically conductive particles of the bed comprises at least 40 wt. % of silicon carbide particles based on the total weight of the electrically conductive particles of the bed; preferably at least 50 wt. %, more preferably at least 60 wt. %, even more preferably at least 70 wt. % and most preferably at least 80 wt. %.

In an embodiment, the electrically conductive particles of the bed may comprise from 10 wt. % to 90 wt. % of electrically conductive particles different from silicon carbide particles based on the total weight of the electrically conductive particles of the bed; preferably, from 15 wt. % to 95 wt. %, more preferably from 20 wt. % to 90 wt. %, even more preferably from 25 wt. % to 80 wt. % and most preferably from 30 wt. % to 75 wt. %.

However, it may be interesting to keep the content of electrically conductive particles different from silicon carbide particles quite low in the mixture. Thus, in an embodiment, the electrically conductive particles of the bed are or comprise a mixture of silicon carbide particles and electrically conductive particles different from silicon carbide particles and electrically conductive particles of the bed comprises from 1 wt. % to 20 wt. % of electrically conductive particles different from silicon carbide based on the total weight of the electrically conductive particles of the bed; preferably, from 2 wt. % to 15 wt. %, more preferably, from 3 wt. % to 10 wt. %, and even more preferably, from 4 wt. % to 8 wt. %.

For example, the electrically conductive particles of the bed are or comprise a mixture of silicon carbide particles and particles different from silicon carbide particles and the said particles different from silicon carbide particles are or comprise graphite particles.

Thus, in an embodiment, the electrically conductive particles are a combination of silicon carbide particles and graphite particles. Such electrically conductive particles, upon the electrification of the fluidized bed reactor and/or the spouted bed reactor, will heat up and because of their fluidification, will contribute to the raise and/or to the maintaining of the temperature within the reactor. The Joule heating of graphite allows accelerating the heating of the reactant and/or of the other particles that are present within the fluidized bed reactor and/or the spouted bed reactor.

For example, graphite can be flake graphite. It is also preferable that the graphite has an average particle size ranging from 1 to 400 μm as determined by sieving according to ASTM D4513-11, preferably from 5 to 300 μm, more preferably ranging from 10 to 200 μm and most preferably ranging from 30 to 150 μm.

The presence of graphite particles in the bed allows applying the process according to the disclosure with or without the pre-heating step, preferably without the pre-heating step. Indeed, the graphite particles, upon the electrification of the fluidized bed reactor and/or the spouted bed reactor, will heat up and because of their fluidification, will contribute to raising and/or maintaining the desired temperature within the reactor.

### The Silicon Carbide Particles

For example, the silicon carbide is selected from sintered silicon carbide, nitride-bounded silicon carbide, recrystallised silicon carbide, reaction bonded silicon carbide and any mixture thereof.

Sintered SiC (SSiC) is a self-bonded material containing a sintering aid (typically boron) of less than 1% by weight.

Recrystallized silicon carbide (RSiC), a high purity SiC material sintered by the process of evaporation-condensation without any additives.

Nitride-bonded silicon carbide (NBSC) is made by adding fine silicon powder with silicon carbide particles or eventually in the presence of a mineral additive and sintering in a nitrogen furnace. The silicon carbide is bonded by the silicon nitride phase (Si₃N₄) formed during nitriding.

Reaction bonded silicon carbide (RBSC), also known as siliconized silicon carbide or SiSiC, is a type of silicon carbide that is manufactured by a chemical reaction between porous carbon or graphite with molten silicon. The silicon reacts with the carbon forming silicon carbide and bonds the silicon carbide particles. Any excess silicon fills the remaining pores in the body and produces a dense SiC—Si composite. Due to the left-over traces of silicon, reaction bonded silicon carbide is often referred to as siliconized silicon carbide. The process is known variously as reaction bonding, reaction sintering, self-bonding, or melt infiltration.

In general, high purity SiC particles have resistivity above 1000 Ohm·cm, whereas sintered, reaction bonded and nitride-bonded can exhibit resistivities of about 100 to 1000 depending on the impurities in the SiC phase. Electrical resistivity of bulk polycrystalline SiC ceramics shows a wide range of resistivity depending on the sintering additive and heat-treatment conditions (Journal of the European Ceramic Society, Volume 35, Issue 15, December 2015, Pages 4137; Ceramics International, Volume 46, Issue 4, March 2020, Pages 5454). SiC polytypes with high purity possess high electrical resistivity (>10⁶ Ω·cm) because of their large bandgap energies. However, the electrical resistivity of SiC is affected by doping impurities. N and P act as n-type dopants and decrease the resistivity of SiC, whereas Al, B, Ga, and Sc act as p-type dopants. SiC doped with Be, O, and V are highly insulating. N is considered the most efficient dopant for improving the electrical conductivity of SiC. For N doping of SiC (to decrease resistivity) Y₂O₃ and Y₂O₃-REM₂O₃ (REM, rare earth metal=Sm, Gd, Lu) have been used as sintering additives for efficient growth of conductive SiC grains containing N donors. N-doping in SiC grains was promoted by the addition of nitrides (AlN, BN, Si₃N₄, TiN, and ZrN) or combinations of nitrides and Re₂O₃ (AlN—REM₂O₃ (REM=Sc, Nd, Eu, Gd, Ho, and Er) or TiN—Y₂O₃).

### The Installation

The terms “bottom” and “top” are to be understood in relation to the general orientation of the installation or the fluidized bed reactor and/or the spouted bed reactor. Thus, “bottom” will mean greater ground proximity than “top” along the vertical axis. In the different figures, the same references designate identical or similar elements.

FIG. 1 illustrates a prior art fluidized bed reactor 1 comprising a reactor vessel 3, a bottom fluid nozzle 5 for the introduction of a fluidizing gas and a biomass and/or waste plastic feedstock, an optional inlet 7 for the material loading, an optional outlet 9 for the material discharge and a gas outlet 11 and a bed 15. In the fluidized bed reactor 1 of FIG. 1 the heat is provided by preheating the feedstock by combustion of fossil fuels using heating means 17 arranged for example at the level of the line that provides the reactor with the fluidizing gas and the biomass and/or waste plastic feedstock.

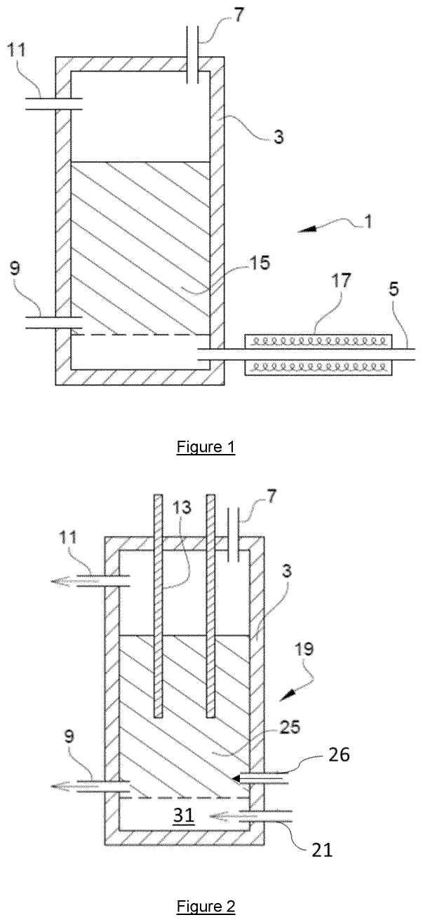

The installation of the present disclosure is now described with reference to FIGS. 2 to 5 schematically for fluidized bed reactors. Installations for the spouted bed reactors are similar, with the difference that the bottom section of the reactor is conical with a narrow inlet diverting to a wider diameter at the end of the conical section, as it can be seen on FIG. 6. For sake of simplicity, internal devices are known by the person in the art that are used in fluidized bed reactors or spouted bed reactors, like bubble breakers, deflectors, particle termination devices, cyclones, ceramic wall coatings, thermocouples, etc., are not shown in the illustrations.

FIG. 2 illustrates a first installation with a fluidized bed reactor 19 where the heating and reaction zone are the same. The fluidized bed reactor 19 comprises a reactor vessel 3, a bottom fluid nozzle 21 for the introduction of a fluidizing gas and a nozzle 26 for the introduction of a biomass and/or waste plastic feedstock above the distributor 31 (and preferably at the level of the bottom of the bed 25), an optional inlet 7 for the material loading, an optional outlet 9 for the material discharge and a gas outlet 11. The fluidized bed reactor 1 of FIG. 2 shows two electrodes 13 submerged in bed 25.

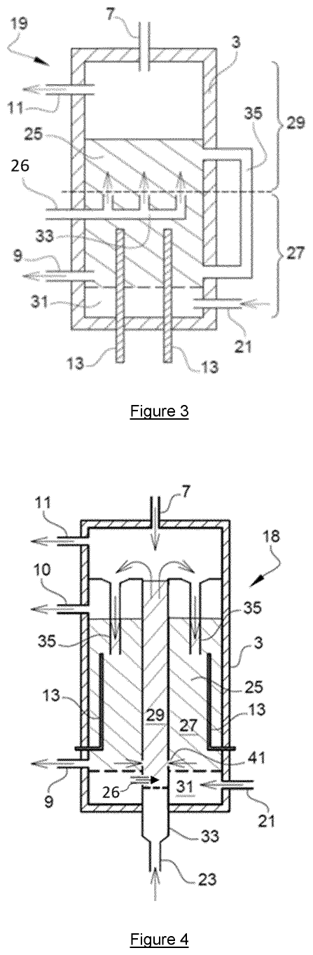

FIG. 3 illustrates an embodiment wherein at least one fluidized bed reactor 19 comprises a heating zone 27 and a reaction zone 29 with the heating zone 27 is the bottom zone and the reaction zone 29 is on top of the heating zone 27. One or more fluid nozzles 26 are arranged to provide a biomass and/or waste plastic feedstock to the reaction zone. As it can be seen in FIG. 3, the one or more fluid nozzles 26 can be connected to a distributor 33 to distribute the biomass and/or waste plastic feedstock inside the bed 25.

FIG. 4 illustrates an installation wherein at least one fluidized bed reactor 18 comprises at least two lateral zones with the outer zone being the heating zone 27 and the inner zone being the reaction zone 29. The heated particles of the bed 25 from the outer zone are transferred to the inner zone by one or more openings 41 and mixed with the biomass and/or waste plastic feedstock that is injected in the reaction zone 29 through one or more nozzles 26 arranged above the distributor 31 (and preferably at the level of the bottom of the bed 25 of the reaction zone 29). The one or more nozzles 23 are arranged to inject fluidisation gases into the reaction zone 29 and are placed below the distributor 31 (namely, not yet within the reaction zone 29). At the end of the reaction the particles are separated from the one or more pyrolysis products and transferred to the heating zone 27.

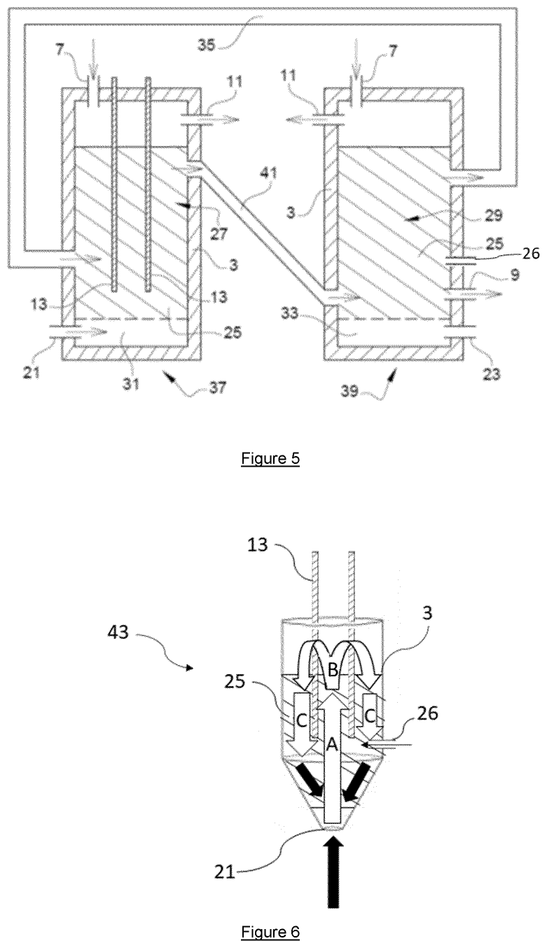

FIG. 5 illustrates the installation that comprises at least two fluidized bed reactors (37, 39) connected one to each other wherein at least one fluidized bed reactor is the heating zone 27 and one at least one fluidized bed reactor is the reaction zone 29.

FIG. 6 illustrates an installation with a spouted bed reactor 43 which is conical. The three regions of the spouted bed reactor 43 are shown: the spouted region A, the fountain region B and the annulus region C. The arrows indicate how the particles of the bed 25 are moving. The spouted bed reactor 43 comprises a reactor vessel 3, a bottom fluid nozzle 21 for the introduction of a fluid stream and a nozzle 26 for the introduction of a biomass and/or waste plastic feedstock. The spouted bed reactor 43 of FIG. 6 shows two electrodes 13 submerged in bed 25.

The present disclosure provides for an installation to be used in a process to perform an endothermic pyrolysis reaction of biomass and/or waste plastic according to the above-defined process, said installation comprises at least one fluidized bed reactor (18, 19, 37, 39) or at least one spouted bed reactor (43) comprising:
at least two electrodes 13,
a reactor vessel 3;
one or more fluid nozzles (21, 23, 26) for the introduction of a fluidizing gas and/or of a biomass and/or waste plastic feedstock within respectively at least one fluidized bed reactor (18, 19, 37, 39) or at least one spouted bed reactor 43; and
a bed 25 comprising particles;
   wherein the particles of the bed 25 comprise at least electrically conductive particles and wherein at least 10 wt. % of the particles of the bed based on the total weight of the particles of the bed 25 are electrically conductive, have a resistivity ranging from 0.001 Ohm·cm to 500 Ohm·cm at 600° C.

For example the electrically conductive particles of the bed are or comprise one or more selected from one or more metallic alloys, one or more non-metallic resistors, one or more metallic carbides, one or more metallic nitrides, one or more metallic phosphides, one or more carbon-containing particles, one or more superionic conductors, one or more phosphate electrolytes, one or more mixed oxides being doped with one or more lower-valent cations, one or more mixed sulphides being doped with one or more lower-valent cations, and any mixture thereof.

For example the electrically conductive particles of the bed are or comprise one or more selected from one or more metallic alloys, one or more non-metallic resistors, one or more metallic carbides, one or more metallic nitrides, one or more metallic phosphides, graphite, carbon black, char, charcoal, coke, petroleum coke, one or more superionic conductors, one or more phosphate electrolytes, one or more mixed oxides being doped with one or more lower-valent cations, one or more mixed sulphides being doped with one or more lower-valent cations, and any mixture thereof.

In an embodiment, from 50 wt. % to 100 wt. % of the electrically conductive particles of the bed based on the total weight of the electrically conductive particles of the bed are one or more selected from graphite, carbon black, char, charcoal, coke, petroleum coke, one or more metallic alloys, one or more non-metallic resistors, one or more metallic carbides, one or more metallic nitrides, one or more metallic phosphides, one or more superionic conductors, one or more phosphate electrolytes, one or more mixed oxides being doped with one or more lower-valent cations, one or more mixed sulphides being doped with one or more lower-valent cations, and any mixture thereof; preferably, from 60 wt. % to 100 wt. %; more preferably from 70 wt. % to 100 wt. %; even more preferably from 80 wt. % to 100 wt. % and most preferably from 90 wt. % to 100 wt. %.

For example, one electrode is a submerged central electrode or two electrodes 13 are submerged within the reactor vessel 3 of at least one reactor (18, 19, 37).

For example, the fluidizing gas is one or more diluent gases.

In a preferred embodiment, the at least one fluidized bed reactor (18, 19, 37, 39) and/or the at least one spouted bed reactor 43 are devoid of heating means. For example, at least one fluidized bed reactor and/or the at least one spouted bed reactor are devoid of heating means selected from ovens, gas burners, hot plates, or any combination thereof. For example, all the fluidized bed reactors and/or all the spouted bed reactors are devoid of heating means selected from ovens, gas burners, hot plates, or any combination thereof. In a preferred embodiment, the at least one fluidized bed reactor and/or the at least one spouted bed reactor, comprising at least two electrodes and a bed comprising particles are devoid of packing.

For example, the reactor vessel 3 has an inner diameter of at least 100 cm, or at least 200 cm; or at least 400 cm. Such a large diameter allows to carry out the chemical reaction at an industrial scale.

The at least one fluidized bed reactor (18, 19, 37) and/or the at least one spouted bed reactor 43 comprise at least two electrodes 13. For example, one electrode is in electrical connection with the outer wall of respectively the fluidized bed reactor and/or the spouted bed reactor, while one additional electrode is submerged into respectively the fluidized bed or the spouted bed, or both electrodes 13 are submerged into respectively the fluidized bed or the spouted bed. Said at least two electrodes 13 are electrically connected and can be connected to a power supply (not shown). It is advantageous that said at least two electrodes 13 are made of graphite. The person skilled in the art will have an advantage that the electrodes 13 are more conductive than the particle bed 25. In an alternative, the said at least two electrodes 13 comprise or are made of tantalum.

For example, at least one electrode 13 is made of or comprises graphite; preferably, all or the two electrodes 13 are made of graphite. For example, one of the electrodes is the reactor vessel, so that the reactor comprises two electrodes, one being the submerged central electrode and one being the reactor vessel 3.

For example, the at least one fluidized bed reactor and/or the at least one spouted bed reactor comprise at least one cooling device arranged to cool at least one electrode.

During use of the fluidized bed reactor or of the spouted bed reactor, an electric potential of at most 300 V is applied, preferably at most 250 V, more preferably at most 200 V, even more preferably at most 150 V, most preferably at most 100 V, even most preferably at most 90 V, or at most 80 V.

Thanks to the fact that the power of the electric current can be tuned, it is easy to adjust the temperature within the reactor bed.

The reactor vessel 3 can be made of graphite. In an embodiment, it can be made of electro-resistive material that is silicon carbide or a mixture of silicon carbide and graphite.

With preference, the reactor vessel 3 comprises a reactor wall made of materials that are corrosion-resistant materials and advantageously said reactor wall materials comprise nickel (Ni), SiAlON ceramics, yttria-stabilized zirconia (YSZ), tetragonal polycrystalline zirconia (TZP) and/or tetragonal zirconia polycrystal (TPZ). SiAlON ceramics are ceramics based on the elements silicon (Si), aluminium (Al), oxygen (O) and nitrogen (N). They are solid solutions of silicon nitride (Si₃N₄), where Si—N bonds are partly replaced with Al—N and Al—O bonds.

For example, the reactor vessel 3 is made of an electro-resistive material that is a mixture of silicon carbide and graphite; and the electro-resistive material of the reactor vessel 3 comprises from 10 wt. % to 99 wt. % of silicon carbide based on the total weight of the electro-resistive material; preferably, from 15 wt. % to 95 wt. %, more preferably from 20 wt. % to 90 wt. %, even more preferably from 25 wt. % to 80 wt. % and most preferably from 30 wt. % to 75 wt. %.

For example, the reactor vessel 3 is made of an electro-resistive material that is a mixture of silicon carbide and graphite.

For example, the reactor vessel 3 is not conductive. For example, the reactor vessel 3 is made of ceramic.

For example, the at least one fluidized bed reactor (18, 19, 37, 39) and/or the at least one spouted bed reactor 43 comprise a heating zone 27 and a reaction zone 29, one or more fluid nozzles 21 to provide a fluidizing gas to at least the heating zone from a distributor 31, one or more fluid nozzles 23 to provide a fluidisation gas to the reaction zone from a distributor 33, one or more fluid nozzles 26 to provide biomass and/or waste plastic feedstock to the reaction zone 29 above the distributor 33 and means 41 to transport the particles from the heating zone 27 to the reaction zone 29 when necessary, and optional means 35 to transport the particles from the reaction zone 29 back to the heating zone 27.

For example, as illustrated in FIG. 3, the at least one fluidized bed reactor is a single one fluidized bed reactor 19 wherein the heating zone 27 is the bottom part of the fluidized bed reactor 19 while the reaction zone 29 is the top part of the fluidised bed reactor 19; with preference, the installation comprises one or more fluid nozzles 26 to inject a biomass and/or waste plastic feedstock between the two zones (27, 29) or in the reaction zone 29. The fluidized reactor 19 further comprises optionally an inlet 7 for the material loading, optionally an outlet 9 for the material discharge and a gas outlet 11. With preference, the fluidized reactor 19 is devoid of heating means. For example, the electrodes 13 are arranged at the bottom part of the fluidized reactor 19, i.e., in the heating zone 27. For example, the top part of the fluidised bed reactor 19, i.e., the reaction zone 29, is devoid of electrodes. Optionally, the fluidized reactor 19 comprises means 35 to transport the particles from the reaction zone 29 back to the heating zone 27; such as by means of a line arranged between the top part and the bottom part of the fluidized bed reactor 19.

For example, as illustrated in FIG. 4, the installation comprises at least two lateral fluidized bed zones (27, 29) connected one to each other wherein at least one fluidized bed zone 27 is the heating zone and at least one fluidized bed zone 29 is the reaction zone. For example, the heating zone 27 is surrounding the reaction zone 29. With preference, the installation comprises one or more fluid nozzles 26 arranged to inject a biomass and/or waste plastic feedstock and/or one or more nozzle 23 arranged to inject a fluidisation gas to the at least one reaction zone 29 by means of a distributor 33. The fluidized bed zones (27, 29) further comprise optionally an inlet 7 for the material loading and a gas outlet 11. With preference, the at least one fluidized bed zone being the heating zone 27 and/or the at least one fluidized bed zone being the reaction zone 29 is devoid of heating means. For example, the at least one fluidized bed zone being the reaction zone 29 shows optionally an outlet 9 for the material discharge. One or more fluid nozzles 21 provide a fluidizing gas to at least the heating zone from a distributor 31. With one or more inlet devices 41, heated particles are transported from the heating zone 27 to the reaction zone 29, and with one or more means 35 comprising downcomers, the separated particles are transported from the reaction zone 29 back to the heating zone 27. The fluidization gas for the heating zone 27 can be an inert diluent, like one or more selected from steam, hydrogen, carbon dioxide, methane, argon, helium, nitrogen, recycled pyrolysis gases or a combination thereof.

For example, as illustrated in FIG. 5, the installation comprises at least two fluidized bed reactors (37, 39) connected one to each other wherein at least one fluidized bed reactor 37 is the heating zone 27 and at least one fluidized bed reactor 39 is the reaction zone 29. With preference, the installation comprises one or more fluid nozzles 23 arranged to inject a fluidisation gas below the distributor 31 and one or more fluid nozzles 26 arranged to inject a biomass and/or waste plastic feedstock above the distributor 31 to the at least one fluidized bed reactor 39 being the reaction zone 29. The fluidized bed reactors (37, 39) further comprise optionally an inlet 7 for the material loading and a gas outlet 11. With preference, the at least one fluidized bed reactor 37 being the heating zone 27 and/or the at least one fluidized bed reactor 39 being the reaction zone 29 is devoid of heating means. For example, the at least one fluidized bed reactor 39 being the reaction zone 29 shows optionally an outlet 9 for the material discharge. By means of the inlet device 41, heated particles are transported from the heating zone 27 to the reaction zone 29 when necessary, and by means of device 35, the separated particles after the reaction zone are transported from the reaction zone back to the heating zone. The fluidization gas for the heating zone can be an inert diluent, like one or more selected from steam, hydrogen, carbon dioxide, methane, argon, helium, nitrogen, recycled pyrolysis gases or a combination thereof.

For example, the at least one fluidized bed reactor 37 being the heating zone 27 comprises at least two electrodes 13 whereas the at least one fluidized bed reactor 39 being the reaction zone 29 is devoid of electrodes.

For example, the at least two fluidized bed reactors (37, 39) are connected one to each other by means 41 suitable to transport the particles from the heating zone 27 to the reaction zone 29, such as one or more lines.

For example, the at least two fluidized bed reactors (37, 39) are connected one to each other by means 35 suitable to transport the particles from the reaction zone 29 back to the heating zone 27, such as one or more lines.

In any of the configurations of FIGS. 2 to 5, the outlet 11 at the top of the fluidized bed reactor (18, 19, 37, 39) can be fluidly connected to a product separation unit (not shown) and more particularly to a separator vessel comprised within said product separation unit. The separator vessel comprises for example at his top a vaporous outlet, to extract the one or more pyrolysis gas and/or the one or more non-condensable compounds and/or the one or more condensable compounds in vapour phase and/or the one or more pyrolysis oils in vapour phase. Also, the separator vessel comprises at his bottom a solid outlet, through which the one or more pyrolysis chars are recovered.

Optionally, the installation further comprises a recycling line to recycle the one or more pyrolysis chars exiting the solid outlet of the separator vessel to the fluidized bed reactor or to the spouted bed reactor of respectively the electrified fluidized bed unit or the electrified spouted bed unit. Thus, at least a part of the pyrolysis char can be sent back to respectively a fluidized bed reactor (18, 19, 37, 39) or a spouted bed reactor and more specifically to the reaction zone 29 either via the material inlet 7, or together with the one or more biomass and/or waste plastic feedstock injection nozzles 26 or via a dedicated char recycle nozzle (not shown) arranged at the level of the reaction zone 29. Alternatively, or additionally, at least a part of the pyrolysis char can be sent back to respectively a fluidized bed reactor (18, 19, 37, 39) or a spouted bed reactor and more specifically to the heating zone 27 either via the material inlet 7, or via a dedicated char recycle nozzle (not shown) arranged at the level of the heating zone 27.

For example, the installation comprises at least two fluidized bed reactors connected one to each other wherein at least one reactor of said at least two fluidized bed reactors is the heating zone and at least another reactor of said at least two fluidized bed reactors is the reaction zone. With preference, the installation comprises one or more fluid nozzles arranged to inject a biomass and/or waste plastic feedstock to the at least one bed reactor being the reaction zone; means to transport the particles of the bed from the heating zone to the reaction zone when necessary; and optional means to transport the particles from the reaction zone back to the heating zone. This configuration is remarkable in that a given particle bed is common to respectively at least two fluidized bed reactor.

For example, the installation comprises at least two spouted bed connected one to each other wherein at least one reactor of said at least two spouted bed reactors is the heating zone and at least another reactor of said at least two spouted bed reactors is the reaction zone. With preference, the installation comprises one or more fluid nozzles arranged to inject a biomass and/or waste plastic feedstock to the bed reactor being the reaction zone; means to transport the particles of the bed from the heating zone to the reaction zone when necessary; and optional means to transport the particles from the reaction zone back to the heating zone. This configuration is remarkable in that a given particle bed is common to at least two spouted bed reactors.

Advantageously, said installation comprises an electrified fluidized bed unit and an electrified spouted bed unit, wherein at least one fluidized bed reactor of the electrified fluidized bed unit is connected to at least one spouted bed reactor of the electrified spouted bed unit, and wherein said at least one fluidized bed reactor is the heating zone and said at least spouted bed reactor is the reaction zone. It is thus preferred that the installation comprises at least one fluidized bed reactor connected to at least spouted bed reactor, wherein said at least one fluidized bed reactor is the heating zone and said at least spouted bed reactor is the reaction zone. Indeed, the pyrolysis of the biomass and/or waste plastic feedstock works better in this configuration.

The Endothermic Pyrolysis Reaction of Biomass and/or Waste Plastic

In one embodiment, the pyrolysis reaction does not require any catalytic composition.

In one embodiment, the pyrolysis reaction is carried out in presence of a catalyst.

Whichever the embodiment selected, said pyrolysis reaction is conducted at a temperature ranging between 400° C. and 900° C., preferably between 425° C. and 800° C.

For example, the said pyrolysis reaction is performed at a pressure ranging between 0.1 MPa and 1.0 MPa, preferably between 0.12 MPa and 0.5 MPa.

The residence time of the vapour of the biomass and/or waste plastic feedstock in the fluidised bed section of the reactor where the temperature is between 40° and 900° C., range from 0.01 to 50.0 seconds, preferably from 0.02 to 25.

### Test and Determination Method

### X-Ray Fluorescence Spectroscopy (XRF)

X-ray fluorescence (XRF) spectroscopy measurements have been taken by using an Orbis Micro-EDXRF spectrometer equipped with a Rh source (15 kV, 500 μA) and a silicon drift detector. XRF measurements were taken on the materials as such (non-dissolved). This was useful for determining the amount of SiO₂ and of Al₂O₃ and subsequently the Si/Al atomic ratio.

### N₂ Sorption Measurements

N₂ sorption analysis was used to determine the nitrogen adsorption/desorption isotherms using Micrometrics ASAP 2020 volumetric adsorption analyser. The samples were degassed at 350° C. under vacuum overnight before the measurement. From these measurements, the specific surface area of the solid acid catalyst has been determined.

1-15. (canceled)

16. A process to perform an endothermic pyrolysis reaction of biomass and/or waste plastic into one or more pyrolysis oils, said process comprising the steps of:
a) providing at least one bed reactor selected from a fluidized bed reactor (18, 19, 37, 39) and/or a spouted bed reactor (43), said bed reactor comprising at least two electrodes (13) and a bed (25) comprising particles;
b) putting the particles of the bed (25) in a fluidized state by passing upwardly through the said bed (25) a fluid stream, to obtain respectively a fluidized bed and/or a spouted bed;
c) heating respectively the fluidized bed and/or the spouted bed to a temperature ranging from 400° C. to 900° C. to conduct the endothermic pyrolysis reaction of a biomass and/or waste plastic feedstock; and
d) recovering one or more pyrolysis oils being one or more pyrolysis products of the reaction;
characterized in that the particles of the bed (25) comprise at least electrically conductive particles and in that at least 10 wt. % of the particles based on the total weight of the particles of the bed (25) are electrically conductive particles and have a resistivity ranging from 0.001 Ohm·cm to 500 Ohm·cm at 600° C. and in that the step c) of heating respectively the fluidized bed and/or the spouted bed is performed by passing an electric current through respectively the fluidized bed and/or the spouted bed.

17. The process according to claim 16, characterized in that the electrically conductive particles of the bed comprise one or more selected from one or more metallic alloys, one or more non-metallic resistors, one or more metallic carbides, one or more metallic nitrides, one or more metallic phosphides, one or more carbon-containing particles, one or more superionic conductors, one or more phosphate electrolytes, one or more mixed oxides being doped with one or more lower-valent cations, one or more mixed sulphides being doped with one or more lower-valent cations, and/or any mixture thereof.

18. The process according to claim 16, characterized in that the electrically conductive particles of the bed comprise one or more carbon-containing particles being graphite, char, charcoal or a mixture thereof and/or in that the electrically conductive particles of the bed comprise one or more non-metallic resistors selected from silicon carbide, molybdenum disilicide or a mixture thereof.

19. The process according to claim 16, characterized in that the electrically conductive particles of the bed comprise a mixture of a non-metallic resistor being silicon carbide and electrically conductive particles different from silicon carbide; with preference:
the electrically conductive particles of the bed comprise from 10 wt. % to 99 wt. % of silicon carbide based on the total weight of the electrically conductive particles of the bed; and/or
the said electrically conductive particles different from silicon carbide are one or more carbon-containing particles and/or one or more mixed oxides being doped with one or more lower-valent cations and/or one or more mixed sulphides being doped with one or more lower-valent cations.

20. The process according to claim 16, characterized in that the electrically conductive particles of the bed comprise one or more mixed oxides being doped with one or more lower-valent cations; with preference, the mixed oxides are selected from:
one or more oxides having a cubic fluorite structure being at least partially substituted with one or more lower-valent cations, preferentially selected from Sm, Gd, Y, Sc, Yb, Mg, Ca, La, Dy, Er, Eu; and/or
one or more ABO₃-perovskites with A and B tri-valent cations, being at least partially substituted in A position with one or more lower-valent cations, preferentially selected from Ca, Sr, or Mg, and comprising at least one of Ni, Ga, Co, Cr, Mn, Sc, Fe and/or a mixture thereof in B position; and/or
one or more ABO₃-perovskites with A bivalent cation and B tetra-valent cation, being at least partially substituted with one or more lower-valent cations, preferably selected from Mg, Sc, Y, Nd or Yb in the B position or with a mixture of different B elements in the B position; and/or
one or more A₂B₂O₇-pyrochlores with A trivalent cation and B tetra-valent cation being at least partially substituted in A position with one or more lower-valent cations, preferentially selected from Ca or Mg, and comprising at least one of Sn, Zr and Ti in B position.

21. The process according to claim 16, characterized in that the electrically conductive particles of the bed comprise
one or more metallic alloys; and/or
one or more superionic conductors; with preference, one or more superionic conductors are selected from LiAlSiO₄, Li₁₀GeP₂S₁₂, Li_{3.6}Si_{0.6}P_{0.4}O₄, sodium superionic conductors, or sodium beta alumina.

22. The process according to claim 16, characterized in that, wherein the at least one fluidized bed reactor (18, 19, 37, 39) and/or the at least one spouted bed reactor (43) provided in step a) comprise a heating zone (27) and a reaction zone (29) and wherein the fluid stream provided in step b) is provided to the heating zone (27) and comprises fluidisation gases, the step c) of heating respectively the fluidized bed and/or the spouted bed to a temperature ranging from 400° C. to 900° C. to conduct the endothermic pyrolysis reaction of a biomass and/or waste plastic feedstock into one or more pyrolysis products, comprises the following sub steps:
heating respectively the fluidized bed and/or the spouted bed to a temperature ranging from 400° C. to 900° C. by passing an electric current through the heating zone of respectively the at least one fluidized bed and/or the at least one spouted bed,
transporting the heated particles from the heating zone (27) to the reaction zone (29),
in the reaction zone (29), putting the heated particles in a fluidized state by passing upwardly through the said bed of the reaction zone (29) a fluid stream comprising fluidisation gases, to obtain respectively a fluidized bed and/or a spouted bed and to conduct the endothermic pyrolysis reaction of a biomass and/or waste plastic feedstock into one or more pyrolysis products.

23. The process according to claim 16, characterized in that the at least one fluidized bed reactor (18, 19, 37, 39) and/or the at least one spouted bed reactor (43) provided in step a) comprise a heating zone (27) and a reaction zone (29), and wherein the step c) of heating respectively the fluidized bed and/or the spouted bed comprises the following sub-steps:
pre-heating respectively the fluidized bed and/or the spouted bed to a temperature ranging from 200° C. to 500° C. by passing upwardly through the particles of the bed (25) a fluidizing stream being a gaseous stream having a temperature ranging from 200° C. to 500° C.;
heating respectively the fluidized bed (25) and/or the spouted bed to a temperature ranging from 400° C. to 900° C. by passing an electric current through the heating zone (27) of the respectively at least one fluidized bed reactor (18, 19, 37, 39) and/or at least one spouted bed reactor (43),
transporting the heated particles from the heating zone (27) to the reaction zone (29),
in the reaction zone (29), putting the heated particles in a fluidized state by passing upwardly through the said bed (25) of the reaction zone (29) a fluid stream comprising fluidisation gases to obtain respectively a fluidized bed (25) and/or a spouted bed and to conduct the endothermic pyrolysis reaction of a biomass and/or waste plastic feedstock into one or more pyrolysis products,
optionally, recovering the particles from the reaction zone (29) and recycling them to the heating zone (27).

24. The process according to claim 16, characterized in that the particles of the bed further comprise particles of a catalytic composition, wherein the catalytic composition comprises one or more solid acid catalysts and/or one or more basic metal oxides catalysts; with preference, the content of the particles of the catalytic composition is ranging from 15 wt. % to 90 wt. % of the particles of the bed.

25. The process according to claim 24, characterized in that the one or more solid acid catalysts have a surface area ranging between 50 m²/g and 800 m²/g as determined by N₂ sorption measurements and/or in that the one or more solid acid catalyst are selected from one or more oxides, one or more mixed oxides, one or more phosphates, one or more zeolites selected from the group of zeolites having at least one 10-membered ring, one or more silicoaluminophosphate molecular sieves or any combinations thereof.

26. An installation to perform an endothermic pyrolysis reaction of biomass and/or waste plastic into one or more pyrolysis oils according to claim 16; wherein said installation comprises:
i) an electrified fluidized bed unit and/or an electrified spouted bed unit with respectively at least one fluidized bed reactor (18, 19, 37, 39) or at least one spouted bed reactor (43) comprising:
at least two electrodes (13);
a reactor vessel (3);
one or more fluid nozzles (21, 23, 26) for the introduction of a biomass and/or waste plastic feedstock within respectively said fluidized bed reactor (18, 19, 37, 39) or said spouted bed reactor (43); and
a bed (25) comprising particles;
ii) a product separation unit being downstream of respectively said electrified fluidized bed unit or said electrified spouted bed unit, the product separation unit comprising a separator vessel being in fluid contact with the top of respectively the fluidized bed reactor (18, 19, 37, 39) and/or the spouted bed reactor (43) of respectively the electrified fluidized bed unit or the electrified spouted bed unit; the separator vessel comprising at his top a vaporous outlet and at his bottom a solid outlet;
the installation is characterized in that the particles of the bed (25) comprise at least electrically conductive particles and in that at least 10 wt. % of the particles based on the total weight of the particles of the bed (25) are electrically conductive particles and have a resistivity ranging from 0.001 Ohm·cm to 500 Ohm·cm at 600° C.; in that the reactor vessel 3 has an inner diameter of at least 100 cm and comprises a reactor wall made of materials that are corrosion-resistant materials, and in that said installation further comprises a recycling line to recycle the pyrolysis char exiting through the solid outlet of the separator vessel to respectively the fluidized bed reactor (18, 19, 37, 39) and/or the spouted bed reactor (43) of respectively the electrified fluidized bed unit and/or the electrified spouted bed unit.

27. An installation according to claim 26, characterized in that said at least one fluidized bed reactor (18, 19, 37, 39) and/or said at least one spouted bed reactor (43) are devoid of heating means located around or inside the reactor vessel (3) wherein the heating means are selected from ovens, gas burners, hot plates or any combination thereof.

28. An installation according to claim 26, characterized in that the at least two electrodes of the fluidized bed reactor (18, 19, 37, 39) and/or the spouted bed reactor (43) of respectively the electrified fluidized bed unit and/or the electrified spouted bed unit are made of tantalum.

29. The installation according to claim 26, characterized in that said installation comprises an electrified fluidized bed unit and an electrified spouted bed unit, wherein at least one fluidized bed reactor (18, 19, 37, 39) of the electrified fluidized bed unit is connected to at least one spouted bed reactor (43) of the electrified spouted bed unit, and wherein said at least one fluidized bed reactor (18, 19, 37, 39) is the heating zone (27) and said at least spouted bed reactor (43) is the reaction zone (43).
